(19) United States
(12) Patent Application Publication
(10) Pub. No.: US 2025/0263347 A1
(43) Pub. Date: Aug. 21, 2025

(54) Efficient Process for Manufacturing Bionutritional Compositions for Plants and Soils

(71) Applicant: Envirokure, Incorporated, Philadelphia, PA (US)

(72) Inventors: Sushil K. BHALLA, Schwenksville, PA (US); Devon K. Hooper, Leesburg, NJ (US)

(73) Assignee: Envirokure, Incorporated, Philadelphia, PA (US)

(21) Appl. No.: 17/794,584

(22) PCT Filed: Jan. 22, 2021
(86) PCT No.: PCT/US2021/014758

§ 371 Date: Jul. 21, 2022

Related U.S. Application Data
(60) Provisional application No. 62/965,320, filed on Jan. 24, 2020.

(51) Int. Cl. C05F 3/00; C05F 11/00; C05F 17/40; C05F 17/60

(52) U.S. Cl. CPC C05F 3/00; C05F 11/00; C05F 17/40; C05F 17/60

(57) ABSTRACT

Processes for manufacturing bionutritional compositions for plants and soils, such as liquid biostimulants and emulsified or solid biofertilizers, from animal manure is disclosed. The processes include the delivery of pure oxygen or oxygen-enriched air to aqueous animal waste slurry and further include subjecting the aqueous animal waste slurry to an autothermal thermophilic aerobic bioreaction. The processes may also include a separation step to separate the digested or decomposed animal waste composition after ATAB into a substantially liquid component and substantially solid component, each capable of being further processed to produce a biostimulant and biofertilizer, respectively. Compositions suitable for use as biostimulants or biofertilizers are also disclosed.

### CROSS REFERENCE TO RELATED APPLICATIONS

This claims benefit of U.S. Provisional Application No. 62/965,320, filed Jan. 24, 2020, the entire contents of which are incorporated by reference herein.

### FIELD OF THE INVENTION

The present invention relates generally to fertilizers and compositions useful for promoting plant growth and healthy soil structure. In particular, processes for manufacturing such bio-organic fertilizers and compositions are disclosed.

### BACKGROUND OF THE INVENTION

Two main categories of crop input products are used in agriculture: fertilizers and pesticides. A fertilizer is typically described as any organic or inorganic material of natural or synthetic origin that is added to supply one or more nutrients essential to the growth of plants.

Fertilizers provide, in varying proportions, the macronutrients, secondary nutrients, and micronutrients required or beneficial for plant growth.

During the last century, there has been extensive use of synthetic fertilizers and pesticides in agriculture. It is now well recognized that the use of synthetic fertilizers adversely impacts the biological properties of soil diminishing its ability to support plant productivity. In addition, the adverse impacts of these chemicals on environment and humans are being recognized (see, e.g., Weisenberger, D. D., 1993, “Human Health Effects of Agrichemical Use,” Hum. Pathol. 24(6): 571-576). Moreover, numerous studies have shown that as soil carbon declines, significant increases in chemical fertilizers are needed to maintain yields, while leaving an estimated 67% of seed potential unrealized (see, e.g., Mulvaney R. L., et al., 2009, J. Environ. Qual. 38(6):2295-2314; Tollenaar, M., 1985, Proceedings of the Conference on Physiology, Biochemistry and Chemistry Associated with Maximum Yield Corn, Foundation for Agronomic Research and Potash and Phosphate Institute. St. Louis, MO, 11-12; NASS Crop Production 2017 Summary (U.S.D.A. 2018)). Accordingly, the recognition of the often-detrimental effect of synthetic fertilizers and pesticides on soil ecology has provided impetus for expanding interest in sustainable and regenerative crop production, including the use of fertilizers, soil stimulants, and pesticides of natural and/or biological origin. Thus, the need for improvements in agriculture and crop protection is apparent in both the organic and conventional agriculture sectors and highlights the need for biologic treatments that can replace or supplement conventional synthetic fertilizers or be used in combination with conventional chemical herbicides/pesticides to maximize crop yield while maintaining soil integrity.

One class of materials being considered for use in the agricultural industry as an alternative and/or supplement to synthetic fertilizers are agricultural biologics, such as biostimulants, biofertilizers, and biopesticides. Biofertilizers and biostimulants are used in the agricultural industry to add nutrients to plants and soil through the natural processes of nitrogen fixation, phosphorus solubilization, and plant growth stimulation through the synthesis of growth-promoting substances. Biofertilizers can be expected to reduce the use of chemical fertilizers and pesticides and, in conventional farming, be used in combination with pesticides to reduce, e.g., chemical-induced stress on the plants themselves. The microorganisms in biofertilizers restore the soil's natural nutrient cycle to improve nutrient availability for plants and build soil organic matter. Through the use of biofertilizers, healthy plants can be grown, while enhancing the sustainability and the health of the soil. In addition, certain microorganisms referred to as plant growth promoting rhizobacteria (PGPR) are extremely advantageous in enriching soil fertility and fulfilling plant nutrient requirements by supplying the organic nutrients through microorganisms and their byproducts.

In addition to conferring benefits to the soil and rhizosphere, PGPRs can influence the plant in a direct or indirect way. For instance, they can increase plant growth directly by supplying nutrients and hormones to the plant. Examples of bacteria which have been found to enhance plant growth, include certain mesophiles and thermophiles, including thermophilic members of genera such as Bacillus, Ureibacillus, Geobacillus, Brevibacillus and Paenibacillus, all known to be prevalent in poultry manure compost. Mesophiles reported to be beneficial for plant growth, include those belonging to the genera Bacillus, Serratia, Azotobacter, Lysinibacillus and Pseudomonas.

PGPRs are also able to control the number of pathogenic bacteria through microbial antagonism, which is achieved by competing with the pathogens for nutrients, producing antibiotics, and the production of anti-fungal metabolites. Besides antagonism, certain bacteria-plant interactions can induce mechanisms in which the plant can better defend itself against pathogenic bacteria, fungi and viruses. One mechanism is known as induced systemic resistance (ISR), while another is known as systemic acquired resistance (SAR) (see, e.g., Vallad, G. E. & R. M. Goodman, 2004, Crop Sci. 44:1920-1934). The inducing bacteria triggers a reaction in the roots that creates a signal that spreads throughout the plant, resulting in the activation of defense mechanisms, such as reinforcement of the plant cell wall, production of antimicrobial phytoalexins and the synthesis of pathogen related proteins. Some of the components or metabolites of bacteria that can activate ISR or SAR include lipopolysaccharides (LPS), flagella, salicylic acid, and siderophores. Thus, there remains a need for nutrient- and PGPR-rich biofertilizers.

In addition to containing PGPR, biofertilizers may contain other types of bacteria, algae, fungi, or a combination of these microorganisms and include nitrogen fixing microorganisms (e.g., Azotobacter, Clostridium, Anabaena, Nostoc, Rhizobium, Anabaena azollae, and Azospirillum), phosphorous solubilizing bacteria and fungi (e.g., Bacillus subtilis, Psuedomonas striata, Penicillium sp., Aspergillus awamori), phosphorous mobilizing fungi (e.g., Glomus sp., Scutellospora sp., Laccaria sp., Pisolithus sp., Boletus sp., Amanita sp., and Pezizella ericae), and silicate and zinc solubilizers (e.g., Bacillus sp.). However, while biofertilizers may increase the availability of plant nutrients and contribute to soil maintenance as compared to conventional chemical fertilizers, finding cost-effective ways to produce biofertilizers enriched with a suitable population of beneficial microorganisms that are free from microbial contamination and other contaminants and that can be used with existing application methods and technology remains a relatively unmet need in the industry.

One particular source of biofertilizer and biostimulant compositions is animal waste. Indeed, animal manure and, in particular, nutrient- and microbe-rich poultry manure, has been a subject of extensive research regarding its suitability as a biofertilizer. It is well established through academic research and on-farm trials that poultry manure can cost-effectively provide all the macro and micro nutrients required for plant growth, as well as certain plant growth promoting rhizobacteria. However, these benefits are contingent on the elimination of plant and human pathogens that are associated with chicken manure. Moreover, significant concerns from the use of raw manure include increased potential for nutrient run off and leaching of high soil phosphorous, as well as transmittal of human pathogens to food. Importantly, U.S. producers and farmers alike must ensure that their manure-based biofertilizers meet the stringent safety regulations for unrestricted use of a manure-based input promulgated by the FDA. See, for example, 21 C.F.R. § 112.51 (2016).

Another issue negatively impacting the agricultural industry is field contamination by weed seeds. Further, manure-based application, especially raw manure application, may actually contribute to weed seed contamination as undigested weed seeds may be present in the animal waste (see Katovich J. et al., “Weed Seed Survival in Livestock Systems,” U. Minn. Extension Servs. & U. Wis. Extension, available at https://www.extension.umn.edu/agriculture). Weed seed contamination often leads to reduced crop yields prompting the need for increased application of chemical herbicides, which may have a negative impact on both plant and human health. Weed seed contamination is especially problematic in the organic agriculture industry where the application of synthetic herbicides is not permitted forcing famers to rely on mechanical cultivators to control weed growth. As composting has been shown to reduce the total volume of runoff and soil erosion as well as the potential for pathogen and weed seed contamination, many states now require poultry manure to be composted prior to field application, leading to advances in composting processes.

Composting can be described as the biological decomposition and stabilization of organic material. The process produces heat via microbial activity, and produces a final product that is stable, substantially free of pathogens and weed seeds. As the product stabilizes, odors are reduced and pathogens eliminated, assuming the process is carried to completion. Most composting is carried out in the solid phase.

The benefits of composting include: (1) enriching soil with PGPR, (2) reduction of microbial and other pathogens and killing of weed seeds; (3) conditioning the soil, thereby improving availability of nutrients to plants; (4) potentially reducing run-off and soil erosion; (5) stabilizing of volatile nitrogen into large protein particles, reducing losses; and (6) increasing water retention of soil. However, the process is time consuming and labor intensive. Moreover, composting is not without significant obstacles including: (1) the requirement for a large surface area for efficient composting; (2) the need for heavy equipment to “turn” piles for thorough composting for commercial use; (3) difficulty in maintaining consistent, proper carbon to nitrogen ratios; (4) the need for uniform heating; (5) transportation of the bulky final product; and (6) the lack of consistency in the product and its application. Additionally, because nutrients are applied in bulk prior to planting, there is a significant potential for nutrients to be lost through run-off. There is also a significant potential for inconsistent decomposition and incomplete pathogen destruction. Furthermore, uneven nutrient distribution in field application is a concern. Lastly, solid compost cannot be used in hydroponics and/or through drip irrigation.

With regard to this last drawback, organic, and conventional growers alike have utilized compost leachate (compost tea) as a liquid biostimulant. The leachate is produced by soaking well-composted material in water and then separating the solid from the liquid fraction. While such liquid material can be utilized in drip irrigation or foliar application, its production remains time consuming and labor intensive, and the liquid product suffers from the same drawbacks as solid compost in that it may still contain pathogenic organisms and its nutrient content is inconsistent. Thus, any residual pathogenic organisms present in the compost tea presents a risk for pathogen replication and contamination and thus may not pass muster under the applicable and stringent federal health and safety regulations.

Some organic fertilizers include fish-based and plant protein-based fertilizers. Fish emulsion products are typically produced from whole salt-water fish and carcass products, including bones, scales and skin. The fish are ground into a slurry, then heat processed to remove oils and fish meal. The liquid that remains after processing is referred to as the fish emulsion. The product is acidified for stabilization and to prevent microbial growth. Fish hydrolysate fertilizers are typically produced from freshwater fish by a cold enzymatic digestion process. While fish fertilizers can provide nutritional supplementation to plants and soil microorganisms, they are difficult to use, in part due to their high acidity and oil-based composition in some instances, which can clog agricultural equipment. Plant protein-based fertilizers are typically produced by hydrolysis of protein-rich plant materials, such as soybean, and are an attractive alternative for growers and gardeners producing strictly vegan products, for instance. However, due to their sourcing, these products can be expensive. Furthermore, none of the above-described fertilizers is naturally biologic: beneficial microorganisms must be added to them.

Nutrient rich liquid and solid biofertilizers can be produced from poultry manure by utilizing aerobic microorganisms that break down the undesired organic materials, such as the processes described in U.S. Pat. No. 9,688,584 B2 and international patent application publication No. WO 2017/112605 A1. However, existing methods of processing poultry manure to produce biofertilizer suffer from a number of drawbacks that include incomplete decomposition of organic matter resulting in poor stability and excess foaming of the bioreactor equipment. The latter causes significant disruption of airflow and subsequent incomplete decomposition of organic material, which typically results in a liquid fertilizer product that clogs sprayers and other field application equipment thereby disrupting farming program operations and increasing costs. Moreover, prior techniques using ATAB followed by centrifugation (e.g., U.S. Pat. No. 9,688,584 B2 and international patent application publication No. WO 2017/112605 A1) produces a solid fertilizer product with insufficient microorganisms/growth promoting compounds to be classified as a biofertilizer.

Thus, there remains a need in the art for more efficient processes for the manufacture of biologically-derived products in both liquid and solid form, which can provide superior plant nutrition, biostimulation, soil conditioning, and improve soil biodiversity while at the same time being safe, easy to use and cost-effective. Such products would provide highly advantageous alternatives to synthetic products currently in use, such as diammonium phosphate, monoammonium phosphate, and urea-ammonium nitrate, and would satisfy growers' requirements for standardization and reliability.

### SUMMARY OF THE INVENTION

Described herein are processes for manufacturing compositions for application to plants and soils. In particular, the processes disclosed herein are capable of producing both solid and liquid bio-organic compositions suitable for use as biostimulants and biofertilizers. Furthermore, these compositions can be made from animal waste, such as poultry manure. In some embodiments, a general-purpose emulsified biofertilizer can be produced. The processes also may incorporate a separation step for producing both a specialty liquid biostimulant and a solid biofertilizer, both of which contain increased amounts of macronutrients, micronutrients, metabolic compounds, and diverse micro-organisms supportive of plant growth as compared to products current being produced using existing methods.

In one aspect, the invention features a process for manufacturing a bionutritional composition from animal waste that includes the steps of (a) adjusting the pH of the animal waste to about 5 to about 8 to produce a stabilized animal waste composition; (b) adjusting moisture content of the stabilized animal waste composition to at least about 75 wt % to produce an aqueous animal waste slurry; (c) subjecting the aqueous animal waste slurry to an autothermal thermophilic aerobic bioreaction (ATAB) to produce a digested animal waste composition, which includes the delivery of pure oxygen or oxygen enriched air to the aqueous animal waste slurry to maintain the aqueous animal waste slurry under aerobic conditions suitable for the growth of thermophilic bacteria for a first period of time and maintaining the aqueous animal waste slurry at a temperature suitable for the growth of thermophilic bacteria for a second period of time; and (d) subjecting the digested animal waste composition to at least one additional processing step comprising (1) emulsifying the digested animal waste composition to produce an emulsified component; or (2) optionally separating a substantially solid component and a substantially liquid component of the digested animal waste composition. In such aspects, the stabilized animal waste composition, the aqueous animal waste slurry, and the digested animal waste composition are all maintained at a pH of at about 5 to about 8 throughout the process. In some versions of the process, the first period of time and the second period of time occur substantially simultaneously. In some embodiments of the process, the animal waste is poultry waste, such as chicken waste.

In some embodiments, the components of the aqueous animal waste slurry are allowed to remain in contact for a period of time prior to the ATAB step. In other embodiments, at least a portion of inorganic solids are removed from the aqueous animal waste slurry prior to the ATAB step. Some versions of the process include both steps of removing at least a portion of inorganic solids from the aqueous animal waste slurry and reducing particle size of organic solids in the aqueous animal waste slurry. In some aspects, inorganic solids are removed from the aqueous animal waste slurry by filtration or by a hydraulic grit remover. In others, reduction of particle size is carried out via a colloidal mill, a homogenizer, a macerator, or a dispersing grinder. For instance, in one embodiment, particle size is reduced via a colloidal mill having a stator configured to produce particle sizes of less than about 1 micron. In one embodiment, the additional processing step includes adjusting the temperature to less than about 40° C. and/or adding a stabilizer, such as, but not limited to humic acid.

In one embodiments, the process further includes the delivery of pure oxygen or oxygen enriched air to the aqueous animal waste slurry prior to step (c) for a third period of time to reduce the concentration of anaerobic compounds in the aqueous slurry. In another embodiment, the aqueous animal waste slurry comprises a residual dissolved oxygen concentration of at least about 1 parts per million. In particular embodiments, the residual dissolved oxygen concentration is at least about 2 parts per million. In others, the pure oxygen or oxygen enriched air is delivered by injection via one or more spargers having a pore grade in the range from about 1 micron to about 3 microns. In yet other aspects, the pure oxygen or oxygen enriched air is injected into the aqueous animal waste slurry in step (c) at a rate of about 0.5 CFM to about 1.5 CFM per 10,000 gallons. In still others, the pure oxygen or oxygen enriched air is injected into the aqueous animal waste slurry prior to step (c) at a rate of about 0.25 CFM to about 1.5 CFM per 10,000 gallons. The anaerobic compounds may include hydrogen sulfide.

In other embodiment, step (b) includes adjusting the moisture content of the stabilized animal waste composition to between about 80 wt % and about 92 wt % to produce the aqueous animal waste slurry. In yet another embodiment, the pH of the animal waste is adjusted by adding an acid, such as citric acid. Suitable variations of the process include heating the aqueous animal waste slurry to a temperature in the range of about 40° C. to about 65° C. before step (c). Moreover, the autothermal thermophilic aerobic bioreaction typically includes heating the aqueous animal waste slurry to a temperature of at least about 55° C. for the second period of time. The aerobic conditions in the autothermal thermophilic aerobic bioreaction may result from a dissolved oxygen level of between about 2 mg/l and about 6 mg/l.

The process may require that the stabilized animal waste composition, the aqueous animal waste slurry, and the digested animal waste composition are maintained at a pH between about 5.5 and about 7.5 throughout the process. In some embodiments, the third period of time is at least about 15 minutes. In other embodiments, the third period of time is at least about 1 hour. In yet other embodiments, both the first period of time and the second period of time are at least about 1 day. In still other embodiments, both the first period of time and the second period of time are at least about 3 days.

The processes described above can be used to produce an emulsified biofertilizer, liquid biostimulant, and/or solid biofertilizer composition for application to plants and soils. In some embodiments, the composition includes one or more phytohormones or secondary metabolites selected from the group consisting of indole-acetic acid, 12-oxophytodienoic acid, jasmonic acid, salicylic acid, indole 3-acetyl-aspartic acid, jasmonyl isoleucine, abscisic acid, pipecolinic acid, N(δ)-acetylornithine, alpha-tocopherol, gamma-tocopherol, traumatic acid, and 3-indolepropionic acid. In other embodiments, the composition includes at least one additive, such as a macronutrient or a micronutrient. In still other embodiments, the compositions are formulated for application to soil or a medium in which a plant is growing or will be grown. In others, they are formulated for application to a seed or plant part.

In particular embodiments, the compositions produced by the above-described processes are suitable for use in an organic program. These compositions can also be admixed with a synthetic or chemical fertilizer or pesticides or other crop inputs for use in conventional agriculture.

Another aspect of the invention features a process for manufacturing a bionutritional composition from animal waste that includes the steps of: (a) adjusting the pH of the animal waste to about 5 to about 8 to produce a stabilized animal waste composition; (b) adjusting moisture content of the stabilized animal waste composition to at least about 75 wt % to produce an aqueous animal waste slurry; (c) allowing the components of the aqueous animal waste slurry to remain in contact for a period of time; (d) reducing particle size of organic solids in the aqueous animal waste slurry; (e) subjecting the aqueous animal waste slurry to an autothermal thermophilic aerobic bioreaction (ATAB) for a pre-determined time to produce a digested animal waste composition; and (f) subjecting the digested animal waste composition to one or more additional processing steps comprising (1) adding a stabilizer to the digested animal waste composition; (2) adjusting temperature of the digested animal waste composition to less than about 40° C.; (3) adding one or more organic nutrients to the digested animal waste composition; and/or (4) optionally separating a substantially solid component and a substantially liquid component of the digested animal waste composition. In such aspects, the ATAB of the aqueous animal waste slurry occurs in one or more bioreactors comprising a pure oxygen or oxygen enriched air delivery system, the delivery system injects the pure oxygen or oxygen enriched air into the aqueous animal waste slurry to maintain the aqueous animal waste slurry under aerobic conditions suitable for the growth of mesophilic and thermophilic bacteria, and the temperature of the aqueous animal waste slurry in the bioreactor is maintained at a temperature between about 55° C. to about 75° C. Additionally, the stabilized animal waste composition, the aqueous animal waste slurry and the digested animal waste composition are maintained at a pH of at about 5 to about 8 throughout the process.

In some embodiments, a colloidal mill, a homogenizer, a macerator, or a dispersing grinder is used to reduce the particle size. For instance, in one particular embodiment, particle size is reduced by a colloidal mill having a stator configured to produce particles sizes of less than about 1 micron. In other embodiments, the process includes a step of removing at least a portion of inorganic solids from the aqueous animal waste slurry prior to the ATAB or particle size reduction steps. For instance, the inorganic solids may be removed from the aqueous animal waste slurry by filtration or by a hydraulic grit remover.

In some embodiments, the pure oxygen or oxygen enriched air delivery system includes one or more spargers having a pore grade in the range from about 1 micron to about 3 microns. In other embodiments, the pure oxygen or oxygen enriched air is injected into the aqueous animal waste slurry at a rate of about 0.25 CFM to about 1.5 CFM per 10,000 gallons. In yet others, the predetermined time is at least about 1 day. In still others, the predetermined time is at least about 3 days.

Other features and advantages of the invention will be apparent by references to the drawings, detailed description and examples that follow.

### BRIEF DESCRIPTION OF THE DRAWINGS

FIG. 1 is a block-diagram of an exemplary embodiment of nutritional composition production process. The dotted lines indicate optional steps.

### DETAILED DESCRIPTION OF THE INVENTION

Described herein is an improved process for producing bio-organic biostimulant and biofertilizer compositions for plants and soils. The compositions produced by the methods and processes of the present disclosure include both liquid and solid products produced from animal manure and related waste products as a starting material. Moreover, the present disclosure provides a production process capable of generating an emulsified biofertilizer as well as microbial- and nutrient-rich liquid biostimulant and solid biofertilizer products that are environmentally safe and fully compatible across all precision agricultural application systems for use in the organic, conventional, and regenerative agricultural industries. In turn, the compositions produced by the processes described herein include biofertilizers and biostimulants that allow for enhanced recycling of nutrients and the regeneration of soil carbon sources as compared to chemical fertilizers.

In particular embodiments, the starting material comprises poultry manure. The process described herein includes subjecting an animal waste slurry to an autothermal thermophilic aerobic bioreaction (ATAB) with the delivery of pure oxygen or oxygen-enriched air to the liquid stream or component. The inventors have discovered a process to subject an animal waste slurry to microbial digestion/decomposition without first having to separate the slurry into liquid and solid streams and while still achieving sufficient decomposition of the waste material. Importantly, the ability to subject the entire slurry to the ATAB process and maintain sufficient thermophilic conditions for a sufficient period of time (e.g., at least 72 hours at a temperature of at least about 55° C.) enables the production of both solid and liquid products that meet the requirements of the National Organic Program and FDA Produce Food Safety requirements.

Moreover, the inventors have combined this innovation with replacement of conventional aeration or other methods that utilize atmospheric sources of oxygen with a pure or enriched-oxygen source reduces the production of foam during the ATAB. The use of pure or enriched-oxygen allows for enhanced oxygen utilization during the ATAB, thereby reducing evaporation, which in turn results in reduced thermal losses, increased operating temperature range, and higher operating temperature thereby increasing organic material decomposition that results in a liquid fertilizer product with increased stability and shelf-life that is less likely to clog or plug spray devices during field application and increased production of plant growth promoting microbial compounds. Additionally, the injection of pure oxygen or oxygen-enriched air into the animal waste composition during initial mixing and stabilization prior to separation prevents formation of undesired compounds formed from microbial anaerobic fermentation, including the toxic and odor-causing hydrogen sulfide, typically found in animal wastes. Thus, the inventors have integrated enhanced oxygen delivery and more efficient microbial digestion/decomposition of a homogenized animal waste slurry to enable the production of a variety of bio-organic products.

To illustrate further, after subjecting the animal waste slurry to ATAB, the digested animal slurry material can then be further processed into a general-purpose emulsified biofertilizer or, alternatively, separated into a liquid fraction and a solid fraction to produce specialty liquid biostimulants and solid biofertilizers, respectively. The inventors have discovered that subjecting the animal waste slurry to the ATAB prior to any separation allows for the production of a general-purpose emulsified biofertilizer with increased shelf-life, micro/macro nutrients, plant and soil beneficial aerobic bacteria, and metabolic compounds as compared to only subjecting a separated liquid fraction to ATAB. Moreover, in some situations, additional steps of degritting and particle size reduction prior to the ATAB enhances the efficiency of the microbial digestion of the animal waste composition during the ATAB process Further, the digested animal waste slurry can be separated following digestion to produce both a liquid biostimulant product as well as a solid biofertilizer product, each with higher levels of plant and soil beneficial aerobic bacteria, Nitrogen (e.g., up to 34% Nitrogen content or higher), and metabolic compounds for enhancing biostimulant activity in plants as compared to the products made with more conventional processes.

An exemplary animal waste suitable for use herein is avian manure and, in particular, poultry manure. Avian manure tends to be very high in nitrogen, phosphorous, and other nutrients, as well as comprising a robust microbial community, that plants require for growth and is therefore suitable for use in embodiments of the present invention. Shown in Table 1 is a comparison of typical nutrient and microbial content contained in manure from several different poultry species.

TABLE 1
Poultry manure nutrients analysis (source: Biol. & Agric. Eng. Dept. NC State University,
January 1994; Agronomic Division, NC Dept of Agriculture & Consumer Services)

| | Unit | | Chicken | | | | |
|---|---|---|---|---|---|---|---|
| Parameter | (mean) | Layer | Broiler | Breeder | Turkey | Duck | Range |
| Moisture | % wet basis | 75 | 21 | 31 | 27 | 63 | 25-79 |
| Volatile | | | | | | | |
| Solids | % dry basis | 74 | 80 | 43 | 73 | 66 | 43-80 |
| TKN | lb/ton | 27 | 71 | 37 | 55 | 17 | 17-71 |
| NH₃N | % TKN | 25 | 17 | 21 | 22 | 22 | 17-27 |
| P₂O₅ | lb/ton | 21 | 69 | 58 | 63 | 21 | 21-69 |
| K₂O | lb/ton | 12 | 47 | 35 | 40 | 13 | 12-47 |
| Ca | lb/ton | 41 | 43 | 83 | 38 | 22 | 22-83 |
| Mg | lb/ton | 4.3 | 8.8 | 8.2 | 7.4 | 3.3 | 3.3-14 |
| S | lb/ton | 4.3 | 12 | 7.8 | 8.5 | 3 | 3-12 |
| Na | lb/ton | 3.7 | 13 | 8.3 | 7.6 | 3 | 3-13 |
| Fe | lb/ton | 2 | 1.2 | 1.2 | 1.4 | 1.3 | 1.2-2 |
| Mn | lb/ton | 0.16 | 0.79 | 0.69 | 0.8 | 0.37 | 0.16-.8 |
| B | lb/ton | 0.055 | 0.057 | 0.034 | 0.052 | 0.021 | 0.021-0.057 |
| Mo | lb/ton | 0.0092 | 0.00086 | 0.00056 | 0.00093 | 0.0004 | 0.0004-0.0092 |
| Zn | lb/ton | 0.14 | 0.71 | 0.62 | 0.66 | 0.32 | 0.14-0.71 |
| Cu | lb/ton | 0.026 | 0.53 | 0.23 | 0.6 | 0.044 | 0.026-0.6 |
| Crude Protein | % dry basis | 32 | 26 | | 18 | | 18-32 |
| Total | col/100 gm | 7.32E+11 | 1.06E+11 | | 5.63E+11 | | |
| Bacteria | | | | | | | |
| Aerobic | col/100 gm | 6.46E+10 | 1.58E+09 | | | | |
| Bacteria | | | | | | | |

TKN, Total Kjeldahl Nitrogen (organic nitrogen, ammonia, and ammonium)

Thus, manure from domestic fowl, or poultry birds, may be especially suitable for use in the present manufacturing methods as they tend to be kept on farms and the like, making for abundant and convenient sourcing. In particular embodiments, the poultry manure is selected from chickens (including Cornish hens), turkeys, ducks, geese, and guinea fowl.

In preferred embodiments, the raw manure used in the present manufacturing process comprises chicken manure. Chicken farms and other poultry farms may raise poultry as floor-raised birds (e.g., turkeys, broilers, broiler breeder pullets) where manure is comprised of the animal feces or droppings as well as bedding, feathers, and the like. Alternatively, poultry farms may raise poultry as caged egg layers that are elevated from the ground and where manure consists mainly of fecal droppings (feces and uric acid) that have dropped through the cage. In particular aspects, the chicken manure is selected from the group consisting of egg layer chickens, broiler chickens, and breeder chickens. In a more particular embodiment, the manure comprises egg layer manure.

A typical composition of chicken manure is shown in Table 2 (analysis in percentage of total composition or ppm). The moisture content can vary from 45% to 70% moisture. In addition to macro and micro nutrients, the manure contains a diverse population of microorganism which have a potential of being PGPR and also pathogenic characteristics. The manufacturing process is designed to reduce or eliminate the pathogenic organisms and cultivate beneficial organisms, including PGPR.

TABLE 2
Raw Chicken Manure Nutrients Analysis

| | | |
|---|---|---|
| Nutrient | Average | Range |

| Ammonium Nitrogen | 0.88% | | 0.29-1.59% |
|---|---|---|---|
| Organic Nitrogen | 1.89% | | 0.66-2.96% |
| TKN | 2.78% | | 1.88-3.66% |
| P₂O₅ | 2.03% | | 1.33-2.93% |
| K | 1.40% | | 0.89-3.01% |
| Sulfur | 0.39% | | 0.13-0.88% |
| Calcium | 3.56% | | 1.98-5.95% |
| Magnesium | 0.36% | | 0.22-0.60% |
| Sodium | 0.33% | | 0.10-0.88% |
| Copper | 90 | ppm | >20 ppm-309 ppm |
| Iron | 490 | ppm | 314 ppm-911 ppm |
| Manganese | 219 | ppm | 100 pm-493 ppm |
| Zinc | 288 | ppm | 97 ppm-553 ppm |

| | | |
|---|---|---|
| Moisture | 51.93% | 31%-71% |
| Total Solids | 49.04% | 69%-29% |
| pH | 7.60 | 5.5-8.3 |
| Total Carbon | 17.07% | 9.10%-29.20% |
| Organic Matter | 22.32% | 15%-30% |
| Ash | 19.00% | 15-25% |
| Chloride | 0.39% | 0.19%-0.80% |

In certain embodiments, the selected poultry manure comprises between about 17 lb/ton and about 71 lb/ton (i.e., between about 0.85% and about 3.55% by weight) total Kjeldahl nitrogen (TKN), which is the total amount of organic nitrogen, ammonia, and ammonium. In particular aspects, the manure comprises about 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, or 71 lb/ton TKN.

The compositions of the invention are produced from the animal waste by a process that combines physical (e.g., mechanical, thermal), chemical, and biological aspects that reduce or eliminate pathogens while promoting the growth of a diverse microbial population and generating metabolic products of those microorganisms, all of which act together to promote plant and soil health, as described in detail below. In this regard, the inventors control the time, temperature, moisture levels, oxidation reduction potential value, dissolved oxygen content, and/or pH in various stages of the process and can alter the microbial and biochemical profile of the compositions. Further, using a pure or enriched source of oxygen at various stages of the process have additional benefits that include preventing excessive foaming, improving oxygen flow to allow for more complete microbial-mediated decomposition of organic material, eliminating odor-causing contaminants, and increasing stability and shelf-life of the finished product.

While not wishing to be bound by theory, the metabolites in the compositions act as precursor building blocks for plant metabolism and can enhance regulatory function and growth. In one aspect, the bacteria in the compositions can produce allelochemicals that can include, for example, siderophores, antibiotics, and enzymes. In another aspect, precursor molecules for the synthesis of plant secondary metabolites can include flavonoids, allied phenolic and polyphenolic compounds, terpenoids, nitrogen-containing alkaloids, and sulfur-containing compounds.

All percentages referred to herein are percentages by weight (wt %) unless otherwise noted.

Ranges, if used, are used as shorthand to avoid having to list and describe each and every value within the range. Any value within the range can be selected, where appropriate, as the upper value, lower value, or the terminus of the range.

The term “about” refers to the variation in the numerical value of a measurement, e.g., temperature, weight, percentage, length, concentration, and the like, due to typical error rates of the device used to obtain that measure. In one embodiment, the term “about” means within 5% of the reported numerical value; preferably, it means within 3% of the reported numerical value.

As used herein, the singular form of a word includes the plural, and vice versa, unless the context clearly dictates otherwise. Thus, the references “a”, “an”, and “the” are generally inclusive of the plurals of the respective terms. Likewise, the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of”.

As used herein, “animal waste” refers to any material that contains animal manure, including litter, bedding, or any other milieu in which animal manure is disposed. In one aspect, “animal waste” comprises avian or fowl manure, more particularly poultry manure (e.g., chicken, turkey, duck, goose, guinea fowl). In particular, “animal waste” comprises chicken manure, for example, from broilers or layers. In other aspects, “animal waste” can refer to waste from other animals, such as, for example, hogs, cattle, sheep, goats, or other animals not specifically recited herein. In yet another aspect, “animal waste” can refer to a mixture of waste products from two or more types of animals, for instance, two or more types of poultry.

The terms “enhanced effectiveness,” “improved effectiveness,” or “increased effectiveness” are used interchangeably herein to refer to enhanced ability of a biostimulant, biofertilizer, synthetic fertilizer, chemical pesticide/herbicide, and other compounds to improve plant health, crop or seed yield, nutrient uptake or efficiency, disease resistance, soil integrity, plant response to stress (e.g., heat, drought, toxins), resistance to leaf curl, etc. For instance, an additive or supplement may be added to a biostimulant, biofertilizer, synthetic fertilizer, or chemical pesticide/herbicide that confers “improved effectiveness” as compared to the equivalent biostimulant, biofertilizer, synthetic fertilizer, or chemical pesticide/herbicide in the absence of that additive. In particular, the biostimulants produced by the methods disclosed herein can be admixed with a synthetic fertilizer or herbicide/pesticide to confer an improvement in plant health, crop or seed yield, nutrient uptake or efficiency, disease resistance, soil integrity, plant response to stress (e.g., heat, drought, toxins), resistance to leaf curl, etc. when compared to an equivalent plant or rhizosphere treated with the synthetic fertilizer or herbicide/pesticide in the absence of the biostimulant. The foregoing plant and soil traits can be objectively measured by the skilled artisans using any number of art-standard techniques suitable for such measurements.

“Poultry litter” refers to the bed of material on which poultry are raised in poultry rearing facilities. The litter can comprise a filler/bedding material such as sawdust or wood shavings and chips, poultry manure, spilled food, and feathers.

“Manure slurry” refers to a mixture of manure and any liquid, e.g., urine and/or water. Thus, in one aspect, a manure slurry can be formed when animal manure and urine are contacted, or when manure is mixed with water from an external source. No specific moisture and/or solids content is intended to be implied by the term slurry.

The term “autothermal thermophilic aerobic bioreaction,” or “ATAB,” is used herein to describe the bioreaction to which the animal waste slurry is subjected in order to produce the liquid and/or biomass nutritional compositions of the present invention. As described below, the term refers to an exothermic process in which the animal waste slurry is subjected to elevated temperature (generated endogenously at least in part) for a pre-determined period of time. Organic matter is consumed by microorganisms present in the original waste material, and the heat released during the microbial activity maintains thermophilic temperatures.

In this regard, a “bioreaction” is a biological reaction, i.e., a chemical process involving organisms or biochemically active substances derived from such organisms. “Autothermal” means that the bioreaction generates its own heat. In the present disclosure, while heat may be applied from an outside source, the process itself generates heat internally.

The term “mesophile” is used herein to refer to an organism that grows best at moderate temperatures typically between about 20° C. and about 45° C.

“Thermophilic” refers to the reaction favoring the survival, growth, and/or activity of thermophilic microorganisms. As is known in the art, thermophilic microorganisms are “heat loving,” with a growth range between 45° C. and 80° C., more particularly between 50° C. and 70° C., as described in detail herein. “Aerobic” means that the bioreaction is carried out under aerobic conditions, particularly conditions favoring aerobic microorganisms, i.e., microorganisms that prefer (facultative) or require (obligate) oxygen.

“Anaerobic” means that the conditions favor anaerobic microorganisms, i.e., microorganisms that are facultative anaerobes, aerotolerant, or are harmed by the presence of oxygen. “Anaerobic” compounds are those that are produced by microorganisms during anaerobic respiration (fermentation).

The term “pure oxygen” as used herein refers to gas that is at least about 96% oxygen and typically in the range from about 96% to about 98% oxygen.

The term “oxygen-enriched air” as used herein refers to air or gas that is at least about 30% oxygen.

The terms “ambient air” or “atmospheric oxygen” are sometimes used interchangeably herein and refer to air in its natural state as found on Earth. “Ambient air” or “atmospheric oxygen” is readily understood by the skilled artisan to mean air that is about 21% oxygen.

The term “endogenous” as used herein refers to substances or processes arising from within—for instance, from the starting material, i.e., the animal waste, or from within a component of the manufacturing process, i.e., the digested animal waste or the separated liquid and solid components, or from within a product of the manufacturing process, i.e., a nutritional composition as described herein. A composition may contain both endogenous and exogenous (i.e., added) components. In that regard, the term “endogenously comprising” refers to a component that is endogenous to the composition, rather than having been added.

The terms “biocontrol agent” and “biopesticide” are used interchangeably herein to refer to pesticides derived from natural materials, such as animals, plants, bacteria, and certain minerals. For example, canola oil and baking soda have pesticidal applications and are considered biopesticides. “Biopesticides” include biochemical pesticides, microbial pesticides, and plant-incorporated-protectants (PIPs). “Biochemical pesticides” are naturally occurring substances that control pests by non-toxic mechanisms. “Microbial pesticides” are pesticides that contain a microorganism (e.g., bacteria, fungus, virus, or protozoan) as the active ingredient. For example, in some embodiments, Bacillus thuringiensis subspecies and strains are used as a “microbial pesticide.” B. thuringiensis produces a mix of proteins that target certain species of insect larvae depending on the particular subspecies or strain used and the particular proteins produced. “PIPs” are pesticidal substances that plants produce from genetic material that has been added to the plant. For instance, in some embodiments, the gene for the B. thuringiensis pesticidal protein is introduced into the plant genome, which can be expressed by the plant to that protein.

As used herein, a “biostimulant” refers to a substance or micro-organism that, when applied to seeds, plants, or the rhizosphere, stimulates natural processes to enhance or benefit nutrient uptake, nutrient efficiency, tolerance to abiotic stress (e.g., drought, heat, and saline soils), or crop quality and yield. “Biostimulants” that include one or more primary nutrients (e.g., nitrogen, phosphorus, and/or potassium) and at least one living microorganism are also biofertilizers. Other “biostimulants” may include plant growth regulators, organic acids (e.g., fulvic acid), humic acid, and amino acids/enzymes.

As used herein, the term “biofertilizer” refers to a substance which contains one or more primary nutrients (e.g., nitrogen, phosphorus, and/or potassium) and living microorganisms, which, when applied to seeds, plant surfaces, or soil, colonize the rhizosphere or the plant structure and promote growth by increasing the availability of primary nutrients to the host plant. “Biofertilizers” include, but are not limited to, plant growth promoting rhizobacteria (PGPR), compost/compost tea, and certain fungi (e.g., mycorrhizae). Examples of bacteria which have been found to enhance plant growth, include both mesophilic bacteria and thermophilic bacteria. Specific thermophilic bacteria that have been shown to enhance plant growth include members of genera such as Bacillus, Ureibacillus, Geobacillus, Brevibacillus, and Paenibacillus, all known to be prevalent in poultry manure compost. Mesophiles reported to be beneficial for plant growth, include those belonging to the genera Bacillus, Serratia, Azotobacter, Lysinibacillus, and Pseudomonas.

The term “organic fertilizer” typically refers to a soil amendment from natural sources that guarantee, at least the minimum percentage of nitrogen, phosphate, and potash. Examples include plant and animal byproducts, rock powder, seaweed, inoculants, and conditioners. If such fertilizers meet criteria for use in organic programs, such as the NOP, they also can be referred to as registered, approved, or listed for use in such programs.

“Plant growth promoting rhizobacteria” and “PGPR” are used interchangeably herein to refer to soil bacteria that colonize the roots of plants and enhance plant growth.

“Plant growth regulator” and “PGR” are used interchangeably herein to refer to chemical messengers (i.e., hormones) for intercellular communication in plants. There are nine groups of plant hormones, or PGRs, recognized currently in the art: auxins, gibberellins, cytokinins, abscisic acid, ethylene, brassinosteriods, jasmonates, salicylic acid and strigolactones.

The term “organic agriculture” is used herein to refer to production systems that sustain the health of soils and plants by the application of low environmental impact techniques that do not employ chemical or synthetic products that could affect both the final product, the environment, or human health.

The term “conventional agriculture” is used herein to refer to production systems which include the use of synthetic fertilizers, pesticides, herbicides, genetic modifications, and the like.

The term “regenerative agriculture” is used herein to refer to a system of farming principles and practices that increases biodiversity, enriches soil, improves watersheds, and enhances ecosystem services.

The term “rhizosphere” as used herein refers to the region of soil in the vicinity of plant roots in which the chemistry and microbiology is influenced by their growth, respiration, and nutrient exchange.

As used herein, a “soil conditioner” is a substance added to soil to improve the soil's physical, chemical, or biological qualities, especially its ability to provide nutrition for plants. Soil conditioners can be used to improve poor soils, or to rebuild soils which have been damaged by improper management. Such improvement can include increasing soil organic matter, improving soil nutrient profiles, and/or increasing soil microbial diversity.

Various publications, including patents, published applications and scholarly articles, are cited throughout the specification. Each of these publications is incorporated by reference herein in its entirety.

### Process:

The manufacturing process generally comprises the following steps: (1) preparation of the starting material (the animal waste, also referred to herein as “feedstock material”) to produce an animal waste slurry; (2) allowing for the components of the animal slurry to remain in contact for a period of time and include one or more of aeration, mixing, and heating of the animal waste slurry; (3) removal of at least a portion of the inorganic solids from the animal waste slurry; (4) optional reduction of particle size; and (5) subjecting the animal waste material to an autothermal thermophilic aerobic bioreaction (ATAB) to produce a digested animal waste composition.

At this point, the digested animal waste composition can be cooled, stored, and optionally formulated with additional organic nutrients and/or stabilized with, e.g., humic acid, to produce a general-purpose emulsified biofertilizer or, alternatively, the digested animal waste composition can be separated into a substantially solid component and a substantially liquid component each of which can be further processed to produce a solid biofertilizer and liquid biostimulant, respectively. The liquid biostimulant can be cooled, optionally formulated with additional organic nutrients, stabilized, and stored. On the other hand, the solid biofertilizer can be dried, dehydrated or granulated at low temperatures at low temperatures to preserve microbial content, It can also be optionally formulated with additional organic nutrients. Finally, the liquid biostimulant products are typically subjected to filtration and/or screening prior to shipping or packaging.

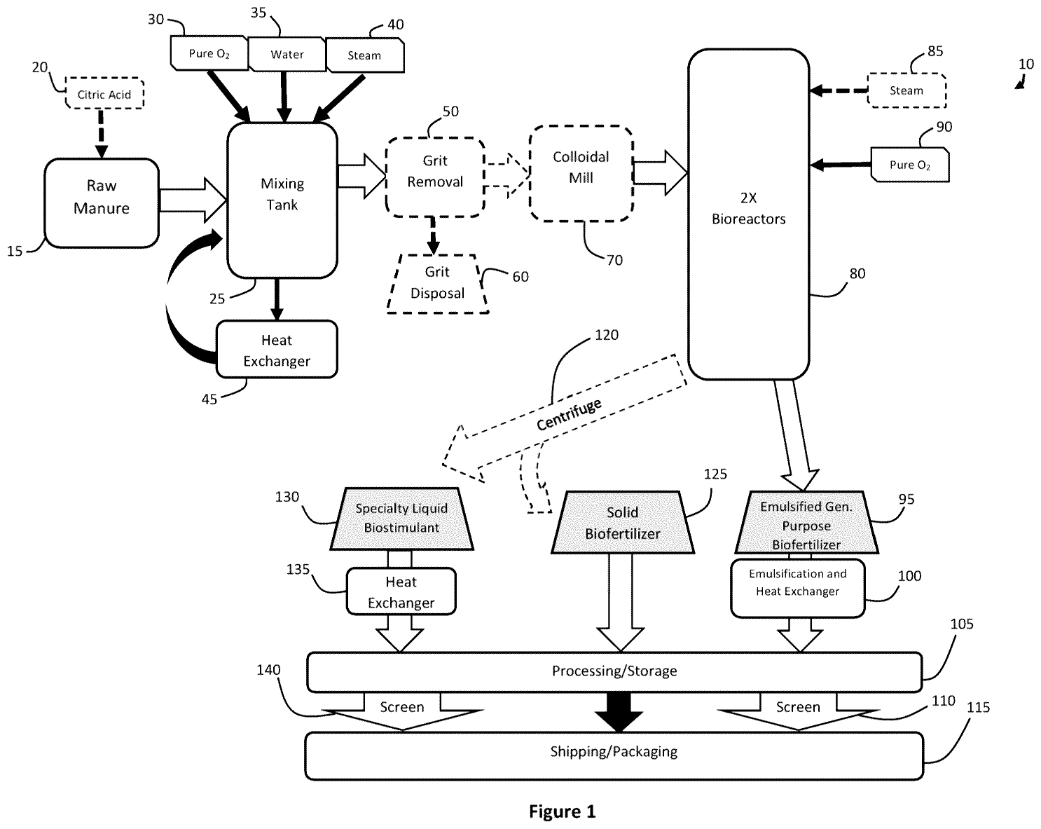

A schematic diagram depicting an exemplary embodiment of the manufacturing process applied to raw manure, such as egg layer chicken manure is shown in FIG. 1 and described further below. If manure is supplied as poultry litter, e.g., from broiler chickens, the bedding is removed prior to initiation of the above-summarized process.

In general, the manufacturing process disclosed herein may include an oxygen supply or delivery system for introducing to various steps in the process pure oxygen or oxygen-enriched air having an oxygen concentration of at least about 30%, e.g., at least about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 95.5%, 96%, 96.5%, 97%, 97.5%, 98%, 98.5%, 99%, 99.1%, 99.2%, 99.3%, 99.4%, 99.5%, 99.6%, 99.7%, 99.8%, or 99.9%. A suitable oxygen supply system can be installed in mixing tanks, bioreactors, and the like. Such oxygen supply systems can be installed in place of typical nozzle mixers and aeration systems supplying atmospheric oxygen (or ambient air). In general, atmospheric oxygen is air or gas that has an oxygen content of about 21%, which is significantly lower than the oxygen supply provided in the present process. Pure oxygen or oxygen-enriched air can be introduced into the slurry preparation step and/or the ATAB step.

As one skilled in the art would understand, gasses can be delivered or injected into liquids using a variety of delivery devices, such as an aspirator, venturi pump, sparger, bubbler, carbonator, pipe or tube, tank/cylinder, and the like. In particular embodiments, the gas delivery device is a sparger. A sparger suitable for use with the oxygen supply systems disclosed herein may consist of a porous construction of any art-standard plastic (such as polyethylene or polypropylene) or metal (such as stainless steel, titanium, nickel, and the like). Pressurized gas (e.g., oxygen) can be forced through the network of pores in the sparger and into an aqueous mixture, such as a slurry or liquid fraction. Pore grades suitable for use herein range from about 0.1 microns to about 5 microns, e.g., about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 microns; preferably, between about 1 and 3 microns. In a particular embodiment, the sparger pore size is from about 1.5 microns to about 2.5 microns. For instance, in one embodiment, the oxygen supply system includes 2-micron sintered stainless steel spargers.

### Slurry Preparation

In the preparation step, the feedstock material is first adjusted for moisture content and, preferably, pH. While in some embodiments the process can be conducted at any pH, it is preferable that the pH be maintained within a desired pH range as described below. In some aspects, an adjustment of pH occurs at the slurry stage or even later in the process. The pH of the feedstock material and/or slurry may be adjusted to neutral or acidic through the addition of a pH adjusting agent, it being understood that the pH can be adjusted prior to or after the adjustment of the moisture. Alternatively, the pH and moisture adjustments can occur simultaneously. In other embodiments, the feedstock pH and/or slurry does not need to be adjusted (i.e., the pH of the feedstock material and/or is already within the desired pH range). Typically, however, the pH of the feedstock material and/or slurry will need to be adjusted. In particular embodiments, the feedstock/slurry is adjusted to a pH of between about 4 and about 8, or more particularly to between about 5 and about 8, or even more particularly to between about 5.5 and about 8 or between about 5.5 and about 7.5. In preferred embodiments, the pH of the slurry is at least about 6.0, or about 6.1, or about 6.2, or about 6.3, or about 6.4, or about 6.5, or about 6.6, or about 6.7, or about 6.8, or about 6.9, or about 7.0, or about 7.1, or about 7.2, or about 7.3, or about 7.4, or about 7.5, or about 7.6, or about 7.7, or about 7.8, or about 7.9. In some embodiments, the slurry is adjusted to a pH of less than about 8, more preferably less than about 7.5. For instance, in one particular embodiment, the feedstock material and/or slurry is adjusted to a pH of about 7 or about 7.5. Acidification of an otherwise non-acidic (i.e., basic) feedstock is important to stabilize the natural ammonia in the manure into non-volatile compounds, e.g., ammonium citrate. Thus, the pH adjustment step produces a stabilized animal waste composition or animal waste slurry. The pH of the stabilized animal waste slurry is maintained within the desired range, e.g.; between about 5 to about 8, or between about 5.5 and about 8, or between about 5.5 and about 7.5, or between about 6 and about 7.8, or about 7 or about 7.5; throughout the entire manufacturing process. In some embodiments, the pH of the finished product is adjusted to a pH of between about 5 and about 6, e.g., about 5.5, prior to storage/packaging/shipping.

An acid is typically used to adjust the pH of the animal waste feedstock and/or slurry. In certain embodiments, the acid is an organic acid, though an inorganic acid may be used or combined with an organic acid. Suitable organic acids include, but are not limited to formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is one typically used to adjust the pH of food or feed. A preferred acid is citric acid. For instance, in some embodiments, citric acid may be used to maintain the pH of the animal waste feedstock and/or slurry within the desired range throughout the entire process.

As noted above, the preparation step also involves adjusting the moisture content of the animal waste material to produce a slurry. The moisture content is adjusted by adding a liquid to form an aqueous slurry that is sufficiently liquid to be flowable from one container to another, e.g., via pumping through a hose or pipe. The liquid may be water or some other liquid supplied from an external source or may be recycled liquid from another step in the process. In certain embodiments, the aqueous animal waste slurry has a moisture content of at least about 80%. More particularly, the aqueous animal waste slurry has a moisture content of at least about 81%, or at least about 82%, or at least about 83%, or at least about 84%, or at least about 85%, or at least about 86%, or at least about 87%, or at least about 88%, or at least about 89%, or at least about 90%, or least about 91%, or at least about 92%, or at least about 93%, or at least about 94%, or at least about 95%, or at least about 96%, or at least about 97%, or at least about 98%, or at least about 99%, with the understanding that about 99% moisture is an upper limit. In particular embodiments, the slurry has a moisture content of between about 80% to about 95%, even more particularly between about 84% and about 88%, or between about 80% and about 92%.

The animal waste slurry preparation may also include the delivery of oxygen to create a more aerobic environment to both prevent formation of anaerobic contaminants produced during microbial fermentation in oxygen depleted conditions and to oxidize anaerobic contaminants. One of these undesirable compounds is hydrogen sulfide, which can result from the anaerobic microbial breakdown of organic matter, such as manure. Hydrogen sulfide is poisonous, corrosive, and flammable with a characteristic odor of rotten eggs. Substantial reduction or elimination of the toxic and odor-causing hydrogen sulfide during the production of the liquid and solid fertilizer products is highly desired. Odor-causing hydrogen sulfide can be oxidized by gaseous oxygen.

In slurry or liquid components, hydrogen sulfide is dissociated into its ionic form illustrated by Equation 1:

H₂S→2H⁺+S⁻² Equation 1

The sulfide ion is then free to react with oxygen according to Equation 2:

2H₂S+O₂→2H₂O+2S Equation 2

The reaction ratio of hydrogen sulfide oxidation is around 1.0. For instance, 1 mg/kg (ppm) of oxygen is required for each ppm of hydrogen sulfide. In some embodiments, the residual dissolved oxygen in the slurry or liquid component is at least about 0.5 ppm, e.g., 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, or more ppm. In a preferred embodiment, the residual dissolved oxygen level in the slurry or liquid component is at least about 1 ppm, more preferably at least about 2 ppm. However, typical slurry mixing tanks supply atmospheric oxygen to the system to reduce the production of compounds formed by the microorganisms' anaerobic metabolism. Atmospheric oxygen sources may provide insufficient oxygen for the elimination of hydrogen sulfide contaminant. Thus, a more efficient oxygen delivery system is desired.

Therefore, to oxidize hydrogen sulfide and other contaminants in the mixing tank during slurry preparation, the preparation step may include an oxygen supply or delivery system for injecting pure or oxygen-enriched air into the slurry, which provides a substantial increase in oxygen delivery as compared to existing aeration systems delivering atmospheric oxygen. The oxygen supply or delivery system may include any suitable means for delivering or injected the oxygen into the slurry, such as one or more spargers, venturi pumps, bubblers, carbonators, pipes, etc. In a particular embodiment, the oxygen supply or delivery system includes a plurality of spargers. In some embodiments, the oxygen is delivered to the mixing tank of the preparation step and/or directly injected into the slurry at a rate of about 0.1 CFM to about 3 CFM per 10,000 gallons of material, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM. In a preferred embodiment, the delivery rate is between about 0.25 CFM and about 1.5 CFM per 10,000 gallons of material. For instance, in one particular embodiment, the oxygen is delivered to the mixing tank of the preparation step and/or directly injected into the slurry at a rate of about 0.25 CFM per 10,000 gallons of material. Thus, the oxygen supply or delivery system disclosed herein increases the residual dissolved oxygen content to meet the desired threshold described above.

The slurry preparation system is designed to prepare a homogeneous slurry in an aqueous medium at a pH of 4 to 8, preferably 5 to 8 and at an elevated temperature. The temperature is elevated at this stage for several purposes, including (1) to promote mixing and flowability of the slurry, (2) to kill pathogens and/or weed seeds, and/or (3) to initiate growth of mesophilic bacteria present in the feedstock. The temperature can be elevated by any means known in the art, including but not limited to conductive heating of the mixing tank, use of hot water to adjust moisture content, or injection of steam, to name a few. In certain embodiments, the slurry is gradually heated to at least about 40° C., or at least about 41° C., or at least about 42C, or at least about 43° C., or at least about 44° C., or at least about 45° C., or at least about 46° C., or at least about 47° C., or at least about 48° C., or at least about 49° C., or at least about 50° C., or at least about 51° C., or at least about 52° C., or at least about 53° C., or at least about 54° C., or at least about 55° C., or at least about 56° C., or at least about 57° C., or at least about 58° C., or at least about 59° C., or at least about 60° C., or at least about 61° C., or at least about 62° C., or at least about 63° C., or at least about 64° C., or at least about 65° C. Typically, the temperature does not exceed about 65° C., or more particularly, it is less than about 65° C., or less than about 60° C. In certain embodiments, the temperature of the slurry is preferably maintained within a temperature range of between about 40° C. and about 65° C.; more preferably between about 40° C. and about 45° C. To ensure pathogen destruction, the fully homogenized slurry is further heated to 65° C. for a minimum of 1 hour. Alternatively, the fully homogenized slurry can be heated to a lower temperature for a longer period of time to kill pathogens, such as between about 46° C. and 55° C. for a period of at about 24 hours to about 1 week, depending on the temperature. For instance, particular time/temperatures can be about 55° C. for about 24 hours or about 46° C. for about 1 week.

The pH-adjusted aqueous animal manure slurry is maintained at the elevated temperature for a time sufficient to break the manure down into fine particles, fully homogenizing the slurry for further processing, and activating the native mesophilic bacteria. In this manner, the various components of the animal waste slurry remain in contact for this period of time. For instance, in certain embodiments, the animal waste slurry is held at the elevated temperature for at least about one hour and up to about 4 hours, e.g., about 1, 1.5, 2, 2.5, 3, 3.5, or 4 hours. In some embodiments, the slurry is subjected to chopping, mixing, and/or homogenization during this phase. In certain embodiments, the preparation step as outlined above is segregated from subsequent steps of the process to reduce the likelihood that downstream process steps could be contaminated with raw manure.

In an exemplary embodiment, the slurry system consists of a tank (e.g., a steel tank or stainless-steel tank), equipped with a chopper/homogenizer (e.g., a macerator or chopper pump), an oxygen supply system (e.g., sparger), pH and temperature controls, and a biofiltration system for off-gases.

An exemplary process consists of charging the tank with water, heating it to about 45° C. or higher, lowering the pH to about 7 or lower, preferably to a pH range of about 5 to about 7, with citric acid. The chopper pump, oxygen supply system (e.g., via spargers), and off gas biofiltration systems are turned on before introducing the feedstock to ensure a moisture content of, e.g., 85 to 90%. It is a batch operation and, in various aspects, can take one to four hours to make a homogeneous slurry. The operation ensures that each particle of the manure is subjected to temperatures of 45° C. or higher for a period of at least one hour to initiate mesophilic decomposition. Further, the injection of pure oxygen or oxygen enriched air reduces or eliminates toxic and odor-causing contaminants, such as hydrogen sulfide, produced by anaerobic fermentation.

In certain embodiments, the aqueous animal waste slurry prepared as described above is transferred from a slurry tank by pumping, e.g., using a progressive cavity pump. Progressive cavity pumps are particularly suitable devices for moving slurries that can contain extraneous materials such as stones, feathers, wood chips, and the like. The transfer line can be directed into a vibratory screen where the screens can be either vibrating in a vertical axial mode or in a horizontal cross mode. The selected vibratory screen will have appropriately sized holes to ensure that larger materials are excluded from the slurry stream. In one embodiment, the screens exclude materials larger than about ⅛ inch in any dimension.

The slurry stream can then be pumped either directly to the next step in the process, or alternatively into storage tanks, which may be equipped with pH and temperature controls and/or an agitation system. In particular embodiments, the storage tanks may also be equipped with an oxygen supply system. In such embodiments, the slurry is kept under aerobic conditions by injecting pure oxygen or oxygen-enriched air at a rate of from about 0.1 CFM to about 3 CFM per 10,000 gallons of slurry, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM per 10,000 gallons of slurry. Preferably, the pure oxygen or oxygen-enriched air is delivered to the slurry at about 0.25 CFM to about 1.5 CFM per 10,000 gallons of slurry, more preferably at about 0.5 CFM per 10,000 gallons of slurry. In some embodiments, the oxygen is delivered via a plurality of spargers such as those described above. By keeping the slurry under aerobic conditions, the formation of anaerobic compounds is avoided. Optionally, the off-gases are subjected to bio-filtration or other means of disposal.

### Degritting

Contained within animal waste feedstock and the aqueous animal waste slurry are various inorganic particles, such as sand, stone, and other grit. Grit can increase wear of the bioreactors, pumps, mixing equipment, centrifuges, and other equipment that may be included in the manufacturing process. As such, removal of grit protects this equipment from wear and reduces energy and maintenance costs. Moreover, the removal of these inorganic particles also enhances the surface availability of the organic components thus increasing the efficiency of microbial digestions/decomposition and improving the quality of the final products. Thus, in preferred embodiments of the process disclosed herein, the aqueous animal waste slurry stream from the mixing tank or storage tank is sent to a system configured for removal of at least a portion of the grit and other course and fine inorganic solids; preferably, the majority of grit and other inorganic solids are removed from the aqueous animal waste slurry.

A variety of grit removal systems can be used with the invention. In some embodiments, the slurry preparation mixing tank is fitted with mesh screens configured for grit capture. Suitable mesh screens range from 18 mesh to 5 mesh (i.e., about 1 mm to about 4 mm), e.g., 18, 16, 14, 12, 10, 8, 7, 6, or 5 mesh; preferably, the mesh screen is 12 mesh to 8 mesh (i.e., about 1.68 mm to about 2.38 mm). For instance, a slurry preparation tank configured for removal of grit may utilize gravity with 10 mesh screens for grit capture and removal.

Other grit washing and removal systems include hydraulic vessels that control the flow of the slurry in such a manner to produce an open free vortex, which, in turn, results in high centrifugal forces with a thin fluid boundary. Grit is then forced to the outside perimeter where it falls by gravity and can be discharged. The animal waste slurry then exits the vessel through a hydraulic valve. In such embodiments, the animal waste slurry is pumped into the hydraulic vessel tangentially at a rate of about 150 gpm to about 1,200 gpm (about 9.5 L/s to about 75.7 L/s), e.g., about 150 gpm, 200 gpm, 250 gpm, 300 gpm, 350 gpm, 400 gpm, 450 gpm, 500 gpm, 550 gpm, 600 gpm, 650 gpm, 700 gpm, 750 gpm, 800 gpm, 850 gpm, 900 gpm, 950 gpm, 1,000 gpm, 1,050 gpm, 1,100 gpm, 1,150 gpm, or 1,200 gpm; preferably, the rate is from about 200 gpm to about 1,000 gpm (about 12.6 L/s to about 63.1 L/s); more preferably, the rate is from about 250 gpm to about 800 gpm (about 15.8 L/s to about 50.5 L/s). For instance, in one particular embodiment, the animal waste slurry is pumped into the grit removal vessel at a rate of about 300 gpm (about 18.9 L/s). This system eliminates the need for a rotating drum filter prior to bioreactor loading while still capturing, washing, and classifying grit as small as about 95 m, or about 90 m, or about 85 m, or about 80 m, or about 75 m, or about 70 m from the animal waste slurry.

Hydraulic systems are available in the art, such as the SLURRYCUP grit washing system from Hydro International (Hillsboro, Oregon, USA). In some embodiments, two or more hydraulic vessels are configured in a series to provide for multiple rounds of grit washing of the animal waste slurry flow. In yet other embodiments, the system can be used with a belt escalator that captures and dewaters the grit output thus reducing solids handling and disposal costs (e.g., GRIT SNAIL, Hydro International, Hillsboro, Oregon, USA).

From the grit removal step, the aqueous animal waste slurry stream can be directed into storage tanks, such as the storage tanks described above. As noted above, these storage tanks are equipped with pH and temperature controls, an agitation system, and/or an oxygen supply system. In such embodiments, the slurry is kept under aerobic conditions by injecting pure oxygen or oxygen-enriched air at a rate of from about 0.1 CFM to about 3 CFM per 10,000 gallons of slurry, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM per 10,000 gallons of slurry. Preferably, the pure oxygen or oxygen-enriched air is delivered to the slurry at about 0.25 CFM to about 1.5 CFM per 10,000 gallons of slurry, more preferably at about 0.5 CFM per 10,000 gallons of slurry. In some embodiments, the oxygen is delivered via a plurality of spargers such as those described above.

In some embodiments, the animal waste slurry can be further processed to reduce particle size, thereby increasing the surface area and supporting more thorough aerobic digestion of the animal waste composition, including animal waste slurries with lower moisture content. Suitable size-reduction equipment includes, but is not limited to, a colloidal mill, a homogenizer, a macerator, or a dispersing grinder. In one embodiment, the present method employs a homogenizer that forces the slurry material through a narrow space while imparting cavitation, turbulence, or some other force at high pressure to create a consistent and uniform animal waste slurry. In another embodiment, a colloidal mill is used. As one having ordinary skill in the art would appreciate, a colloidal mill includes a rotor that rotates at high velocity on a stationary stator containing many small slots. The rotor-stator mixer pushes the slurry through the slots of the stator, thereby reducing particle sizes to less than about 1.5 microns, e.g., 1.5 microns, 1.4 microns, 1.3 microns, 1.2 microns, 1.1 microns, 1 micron, 0.9 microns, 0.8 microns, 0.7 microns, 0.6 microns, 0.5 microns, 0.4 microns, or less; preferably less than about 1 micron. In a preferred embodiment, the process includes a size reduction step that includes a macerator or a colloidal mill for reducing the size of the organic particles to less than about 1 micron.

### Autothermal Thermophilic Aerobic Bioreaction

The next step involves subjecting the animal waste slurry to an autothermal thermophilic aerobic bioreaction (ATAB). ATAB is an exothermic process in which the animal waste composition with finely suspended solids is subjected to elevated temperature for a pre-determined period of time. Organic matter is consumed by microorganisms present in the original waste material, and the heat released during the microbial activity maintains mesophilic and/or thermophilic temperatures thereby favoring the production of mesophilic and thermophilic microorganisms, respectively. Autothermal thermophilic aerobic bioreaction produces a biologically stable product, which contains macro- and micro-nutrients, PGPR, secondary metabolites, enzymes, and PGR/Phytohormones

In previously existing methods, after grit removal, the slurry is typically subjected to solid/liquid separation. In these processes, the liquid component contains only about 4% to about 6% of the animal waste, which is then subjected to ATAB step. In addition, the solid material being produced by these methods does not meet NOP standards without inclusion of a drying step, which destroys the beneficial bacteria. Accordingly, this separation step removes valuable, plant important, non-water soluble nutrients from the liquid component. Moreover, such a process allows only for efficient ATAB digestion of the liquid stream. As such, only about 15% to about 25% of the aqueous animal waste slurry is subjected to the ATAB step. In turn, the solid material being produced is a nutrient rich fertilizer and soil amendment, but not a higher value biostimulant or biofertilizer. As such, the inventors having developed the present system that does not require separation prior to ATAB and may include the degritting and/or size reduction steps described above to allow efficient microbial decomposition of the entire aqueous animal waste slurry during the ATAB step. In this manner, and as explained below, both liquid biostimulant and solid bio-organic fertilizer products can be produced with adequate nutrients and metabolic compounds according to meet commercial needs and the NOP standards.

In certain embodiments, the elevated temperature conditions are between about 45° C. and about 80° C. More particularly, the elevated temperature conditions are at least about 46° C., or 47° C., or 48° C., or 49° C., or 50° C., or 51° C., or 52° C., or 53° C., or 54° C., or 55° C., or 56° C., or 57° C., or 58° C., or 59° C., or 60° C., or 61° C., or 62° C., or 63° C., or 64° C., or 65° C., or 66° C., or 67° C., or 68° C., or 69° C., or 70° C., or 71° C., or 72° C., or 73° C., or 74° C., or 75° C., or 76° C., or 77° C., or 78° C., or 79° C. In particular embodiments, the elevated temperature conditions are between about 45° C. and about 75° C., more particularly between about 45° C. and about 70° C., more particularly between about 50° C. and about 70° C., more particularly between about 55° C. and about 65° C., and most particularly between about 60° C. and about 65° C. In certain embodiments, the animal waste slurry is maintained in the ATAB under gentle agitation (e.g., full turnover occurs about 10 to about 60 times per hour).

In general, the temperature of the ATAB gradually increases to the mesophilic phase and then to the thermophilic phase. It being understood by one having ordinary skill in the art that the mesophilic phase is at a temperature range in which mesophiles grow best (e.g., about 20° C. to about 45° C.). As the temperature increases above 20° C. to about 40° C., the animal waste slurry enters a mesophilic phase thereby enriching for mesophiles. In some embodiments, the mesophilic phase temperature is between about 30° C. and about 40° C., e.g., about 30° C., 31° C., 32° C., 33° C., 34° C., 35° C., 36° C., 37° C., 38° C., 39° C., or 40° C. In other embodiments, the mesophilic phase temperature is about 35° C. to about 38° C. In such embodiments, the animal waste slurry is maintained at mesophilic phase temperatures for a period of 1 hour to several days, e.g., at least about 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, 1 day, 2 days, 3 days, 4 days, or 5 days. In preferred embodiments, the animal waste slurry is maintained at mesophilic phase temperatures for a period of about 1 to 4 days; more preferably, about 1 to 3 days. For instance, in one particular embodiment, the animal waste slurry is maintained at mesophilic phase temperatures for about 3 days. As the temperature continues to increase, the animal waste slurry enters a thermophilic phase thereby enriching for thermophiles. It being understood by one having ordinary skill in the art that the thermophilic phase is at a temperature range in which thermophiles grow best (e.g., about 40° C. to about 80° C.). In some embodiments, the thermophilic phase temperature is between about 45° C. and about 80° C., e.g., about 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., or 80° C. In other embodiments, the thermophilic phase temperature is about 50° C. to about 70° C. In yet other embodiments, it is preferred that the thermophilic phase temperature is at least about 55° C.; more preferably, the animal waste slurry is maintained at a temperature range of between about 60° C. and about 65° C. for at least a portion of time.

In certain embodiments, the animal waste slurry is maintained at the elevated temperature for a period of several hours to several days. A range of between 1 day and 14 days is often used. In certain embodiments, the conditions can be maintained for 1, 2, 3, 4, 5, 6, 7, 8, 9, or more days; preferably, 1 to 8 days. For purposes of guidance only, the bioreaction is maintained at the elevated temperature for a longer period, e.g., three or more days, to ensure suitable reduction of pathogenic organisms, for instance to meet guidelines for use on food portions of crops. For instance, NOP standards require that the animal waste slurry has been subjected to temperatures of at least about 55° C. for a period of 72 hours or more. However, inasmuch as the length of the bioreaction affects the biological and biochemical content of the bio-reacted product, other times may be selected, e.g., several hours to one day or two days. In particular embodiments, after being maintained at the elevated temperature suitable for thermophilic bacteria, the temperature of the animal waste slurry gradually decreases into the mesophilic temperature range where it is maintained at mesophilic phase temperatures until the liquid component is flash pasteurized or run through a heat exchanger to rapidly drop the temperature, either of which, in many cases, causes the bacteria to produce spores.

One challenge in operating under aerobic thermophilic conditions is to keep the process sufficiently aerobic by meeting or exceeding the oxygen demand while operating at the elevated temperature conditions. One reason this is challenging is that as the process temperature increases, the saturation value of the residual dissolved oxygen decreases. Another challenge is that the activity of the mesophilic and thermophilic micro-organisms increases within increasing temperature, resulting in increased oxygen consumption by the microorganisms. Because of these factors, greater amounts of oxygen, in various aspects, should be imparted into the biomass-containing solutions.

As described in WO 2017/112605 A1, the content of which is incorporated herein in its entirety, existing bioreactors use aeration devices, such as jet aerators, to deliver atmospheric oxygen to the bioreactor due to high oxygen transfer efficiency, the capability for independent control of oxygen transfer, superior mixing, and reduced off-gas production. However, atmospheric oxygen causes excess foaming inside the bioreactor thereby impeding the efficiency of the oxygen supply and causing frequent shut down of the air supply. In some instances, for example, the level of foaming can exceed several feet, e.g., 1, 2, 3, 4, 5, 6, 7, 8 feet or more when atmospheric air is supplied. In turn, the inadequate air supply and reaction disruption results in incomplete decomposition of undesirable organic material. What is more, an increase in undecomposed solids suspended in the substantially liquid stream is difficult to remove and frequently results in liquid fertilizer that plugs spray equipment during field application thereby halting field operations. Moreover, undecomposed solids that are present in the final bionutritional composition products decreases stability and shelf-life.

Thus, to overcome these obstacles, in a particular embodiment pure oxygen or oxygen-enriched air is delivered to the bioreactor and injected or otherwise delivered into the animal waste slurry at a rate of from about 0.1 CFM to about 5 CFM per 1,000 gallons of liquid component, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 CFM per 1,000 gallons of animal waste slurry. In preferred embodiments, the pure oxygen or oxygen-enriched air is delivered to the bioreactor and injected or otherwise delivered into the animal waste slurry at a rate of from about 0.5 CFM to about 1.5 CFM per 1,000 gallons of animal waste slurry, more preferably the rate is about 1.0 CFM per 1,000 gallons of animal waste slurry.

In particular embodiments, pure oxygen or oxygen-enriched air is delivered to the bioreactor by using a plurality of spargers as described above. For instance, one or more 2-micron sintered stainless steel spargers may be used to inject pure oxygen or oxygen-enriched air into the animal waste slurry during ATAB. Keeping the animal waste slurry under aerobic conditions will cultivate and enrich for aerobic, mesophilic and thermophilic bacteria. In particular embodiments, the initial decomposition of the organic material in the animal waste slurry is carried out by mesophilic organisms, which rapidly break down the soluble and readily degradable compounds. The heat the mesophilic organisms produce causes the temperature during ATAB to increase rapidly thereby enriching for thermophilic organisms that accelerate the breakdown of proteins, fats, and complex carbohydrates (e.g., cellulose and hemicellulose). As the supply of these high-energy compounds become exhausted, the temperature of the animal waste slurry gradually decreases, which promotes mesophilic organisms once again resulting in the final phase of “curing” or maturation of the remaining organic matter in the animal waste slurry. Thus, the replacement of atmospheric oxygen supply with a pure oxygen or oxygen-enriched supply substantially reduced the amount of foam produced in the bioreactor during ATAB. The reduction in foam, in turn, allowed for more efficient air supply, more consistent bioreactor operation, and a more robust aerobic environment thereby resulting in a substantial reduction in undecomposed organic material and a more stable and cost-efficient final product.

The ATAB conditions described herein allow for the growth and enrichment of several thermophilic and mesophilic microorganisms for use as PGPR. Beneficial thermophilic and mesophilic microorganisms that can be isolated from the animal waste slurry include, but are not limited to, Bacillus sp. (e.g., B. isronensis strain B3W22, B. kokeshiiformis, B. licheniformis, B. licheniformis strain DSM 13, B. paralicheniformis, B. paralicheniformis strain KJ-16), Corynebacterium sp. (e.g., C. efficiens strain YS-314), Idiomarina sp. (e.g., I. indica strain SW104), Oceanobacillus sp. (e.g., O. caeni strain S-11), Solibacillus sp. (e.g., S. silvestris strain HR3-23), Sporosarcina sp. (e.g., S. koreensis strain F73, S.luteola strain NBRC 105378, S. newyorkensis strain 6062, S. thermotolerans strain CCUG 53480), and Ureibacillus sp. (e.g., U. thermosphaericus). In turn, these bacteria produce various phytohormones and other secondary metabolites that function as plant growth regulators as summarized in Table 3 below.

TABLE 3
Phytohormones/secondary metabolites and their function

| Name | Type | Function |
|---|---|---|
| Indole-acetic Acid | Phytohormone | Induces cell elongation and cell division supporting plant growth and development |
| 12-oxophytodienoic | Jasmonate | Promotes plant wound healing and induces resistance to pathogens and pests |
| Acid | metabolite | |
| Jasmonic Acid | Phytohormone | Signals in resistance to certain bacterial and fungal pathogens and against insect and |
| | | nematode pests |
| Salicylic Acid | Phytohormone | Critical for plant defense against broad spectrum of pathogens. SA is also involved in |
| | | multi-layered defense responses |
| Indole 3-acetyl- | Metabolite | Stimulates root production and elongation; Indole-3-acetyl-L-aspartic acid is a |
| aspartic Acid | | naturally occurring auxin conjugate that regulates free indole-3-acetic acid levels in |
| | | various plant species |
| Jasmonyl Isoleucine | Formal | Stimulates plant defensive mechanisms against herbivore and pathogen attack |
| | condensation of | |
| | carboxy group | |
| | of (3R)- | |
| | jasmonic | |
| | acid with | |
| | the amino group | |
| | of L-isoleucine | |
| Abscisic Acid | Phytohormone | Functions in many plant developmental processes, including protection of buds during |
| | | dormancy; a plant hormone which promotes leaf detachment, induces seed and bud |
| | | dormancy, and inhibits germination |
| Pipecolinic Acid | α-amino acids | Regulates plant systemic acquired resistance and basal immunity to bacterial pathogen |
| | | infection |
| N(δ)-acetylornithine | Biosynthesis of | Regulation of plant immunity; non-protein amino acid likely to play a role in plant |
| | arginine | nitrogen storage (see https://www.ncbi.nlm.nih.gov/pmc/articles/PMC3203426/) |
| Alpha-tocopherol, | Vitamin E | Lipophilic antioxidants that are synthesized exclusively in photosynthetic organisms. |
| Gamma-tocopherol | | Alpha-tocopherol accumulates predominantly in photosynthetic tissue, seeds are rich |
| | | in gamma-tocopherol. |
| Traumatic Acid | Hormone | Potent wound healing agent in plants, stimulates cell division near a trauma site to |
| | | form a protective callus and to heal the damaged tissue |
| 3-Indolepropionic | Phytohormone | Plant hormone with numerous cell growth functions including cell division, |
| Acid | (auxin) | elongation, autonomal loss of leaves, and the formation of buds, roots, flowers, and |
| | | fruit. |

In one aspect, a well configured oxygen supply system should maintain dissolved oxygen levels of between about 1 mg/L and about 8 mg/L, e.g., about 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1., 7.2, 7.3, 7.4, 7.5, 7.6, 7.7, 7.8, 7.9. or 8.0 mg/L. In a preferred embodiment, the oxygen supply system should maintain dissolved oxygen levels of between about 2 mg/L and about 6 mg/L; more preferably, between about 3 mg/L and about 4 mg/L. In certain embodiments, oxygenation of the bioreaction is measured in terms of oxidation-reduction potential (ORP). Typically, the ORP of the bioreaction is maintained between about −580 mV to about +70 mV. More particularly, it is maintained within a range of between −250 mV and +50 mV; more preferably, it is maintained within a range of between −200 mV and +50 mV.

To monitor the temperature, pH, and oxygenation parameters of the ATAB, the bioreactor can be equipped with automated controllers to control such parameters. In some embodiments, the bioreactor is equipped with a programmable logic controller (PLC) that effectively controls pH, ORP, and other parameters by adjusting oxygen air supply and feed rate of a pH adjuster to the bio-reactor. In fact, the delivery of oxygen to any of the process steps disclosed herein can be controlled using a PLC in this manner.

### Optional Separation and Formulation

The digested animal waste composition after the ATAB can be further processed to produce a general-purpose emulsified biofertilizer or a separated solid biofertilizer and liquid biostimulant. For production of the general-purpose emulsified biofertilizer, the digested animal waste composition is pumped from the ATAB bioreactor(s) and emulsified, cooled, and stored. The emulsifying can be carried out using art standard means. For instance, in one embodiment, the digested animal waste composition is processed through a colloidal emulsifier. Likewise, the cooling can be facilitated by any art standard means, such as by way of a heat exchanger. The digested animal waste composition is cooled to a temperature in the range from about 25° C. to about 45° C., e.g., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., or 45° C.; preferably from about 30° C. to about 40° C. For instance, in one embodiment, the digested animal waste composition is cooled to about 35° C. Further, the pH is adjusted to a pH of about 5 to about 6.5; preferably, the pH is about 5.5. Suitable acids for pH adjustment include formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is citric acid. In another embodiment, the digested animal waste composition can be stabilized with humic acid.

Further, the emulsified biofertilizer produced herein will contain at least one phytohormone or secondary metabolite selected from the group consisting of indole-acetic acid, 12-oxophytodienoic acid, jasmonic acid, salicylic acid, indole 3-acetyl-aspartic acid, jasmonyl isoleucine, abscisic acid, pipecolinic acid, N(δ)-acetylomithine, alpha-tocopherol, gamma-tocopherol, traumatic acid, and 3-indolepropionic acid. In other aspects, the emulsified biofertilizer produced herein will contain at least two phytohormones or secondary metabolites, preferably, it will contain at least three phytohormones or secondary metabolites. The phytohormones or secondary metabolites, in turn, can enhance plant growth and development. Finally, the final general-purpose emulsified biofertilizer may be supplemented with additional organic nutrients as described below.

In some embodiments, it is desired to separate the digested animal waste composition into a substantially solid component and a substantially liquid component. Thus, following ATAB, the digested animal waste composition is pumped from the bioreactor(s) to a separation system (e.g., a centrifuge or belt filter press) for the next step of the process. The solid-liquid separation system can include, but is not limited to, mechanical screening or clarification. Suitable separation systems include centrifugation, filtration (e.g., via a filter press), vibratory separator, sedimentation (e.g., gravity sedimentation), and the like. In some embodiments, a two-step separation system may be used, e.g., a centrifugation step followed by a vibratory screen separation step.

In a non-limiting exemplary embodiment, the method employs a decanter centrifuge that provides a continuous mechanical separation. The operating principle of a decanter centrifuge is based on gravitational separation. A decanter centrifuge increases the rate of settling through the use of continuous rotation, producing a gravitational force between 1000 to 4000 times that of a normal gravitational force. When subjected to such forces, the denser solid particles are pressed outwards against the rotating bowl wall, while the less dense liquid phase forms a concentric inner layer. Different dam plates are used to vary the depth of the liquid as required. The sediment formed by the solid particles is continuously removed by the screw conveyor, which rotates at different speed than the bowl. As a result, the solids are gradually “ploughed” out of the pond and up the conical “beach”. The centrifugal force compacts the solids and expels the surplus liquid. The compacted solids then discharge from the bowl. The clarified liquid phase or phases overflow the dam plates situated at the opposite end of the bowl. Baffles within the centrifuge casing direct the separated phases into the correct flow path and prevent any risk of cross-contamination. The speed of the screw conveyor can be automatically adjusted by use of the variable frequency drive (VFD) in order to adjust to variation in the solids load. In some embodiments, polymers may be added to the separation step to enhance separation efficiency and to produce a drier solids product. Suitable polymers include polyacrylamides, such as anionic, cationic, nonionic, and Zwitterion polyacrylamides.

Thus, the separation process results in formation of a substantially solid component and a substantially liquid component of the digested animal waste composition. The term “substantially solid” will be understood by the skilled artisan to mean a solid that has an amount of liquid in it. In particular embodiments, the substantially solid component may contain, e.g., from about 40% to about 64% moisture, often between about 48% and about 58% moisture, and is sometimes referred to herein as “solid,” “cake,” or “wet cake.” Likewise, the term “substantially liquid” will be understood to mean a liquid that has an amount or quantity of solids in it. In particular embodiments, the substantially liquid component may contain between about 2% and about 15% solids (i.e., between about 85% and about 98% moisture), often between about 4% and about 7% solids, and is sometimes referred to herein as “liquid,” “liquid component,” or “centrate” (the latter if the separation utilizes centrifugation).

The substantially solid component is stabilized to produce the biomass/biofertilizer product by adjusting the pH to a pH of about 5 to about 6.5; preferably, the pH is about 5.5. Suitable acids for pH adjustment include formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is citric acid. In another embodiment, the solid biofertilizer can be stabilized with humic acid. Importantly, performing the separation after ATAB produces a solid biofertilizer with metabolic compounds leading to enhanced biostimulant activity as compared to a separated solid biofertilizer product without having been subjected to ATAB. Finally, the final solid biofertilizer is supplemented with additional organic nutrients as described below. In some embodiments, the final solid biofertilizer product is further dried/dehydrated at low temperature to preserve the microbial and biostimulatory components and facilitate storage and handling/shipping (lower weight without water). For instance, the substantially solid component typically has a moisture content of between about 40% about 75%, preferably between about 55% and about 65%, following the separation step. The substantially solid component is subjected to dehydration at a temperature of less than about 100° C. (e.g., 60° C., 65° C., 70° C., 75° C., 80° C., 85° C., 90° C., or 99° C.) for a period of time ranging from about 15 minutes to about 6 hours or until the final moisture content of the final solid biofertilizer is about 10% to about 20%. Suitable dehydration apparatus include, but are not limited to, a rotary drum, fixed fluid bed, or vacuum drier.

The substantially liquid component can be further processed (e.g., cooled and acidified) to produce a liquid biostimulant. As with the general-purpose product discussed above, the cooling of the substantially liquid component can be facilitated by any art standard means, such as by way of a heat exchanger. The substantially liquid component is cooled to a temperature in the range from about 25° C. to about 45° C., e.g., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., or 45° C.; preferably from about 30° C. to about 40° C. For instance, in one embodiment, the substantially liquid component is cooled to about 35° C. Further, the pH is adjusted to a pH of about 5 to about 6.5; preferably, the pH is about 5.5. Suitable acids for pH adjustment include formic acid (methanoic acid), acetic acid (ethanoic acid), propionic acid (propanoic acid), butyric acid (butanoic acid), valeric acid (pentanoic acid), caproic acid (hexanoic acid), oxalic acid (ethanedioic acid), lactic acid (2-hydroxypropanoic acid), malic acid (2-hydroxybutanedioic acid), citric acid (2-hydroxypropane-1,2,3-tricarboxylic acid), and benzoic acid (benzenecarboxylic acid). Preferably, the acid is citric acid. In another embodiment, the substantially liquid component can be stabilized with humic acid. Finally, the final liquid biostimulator is supplemented with additional organic nutrients as described below.

The base products (i.e., the general-purpose emulsified biofertilizer, solid biofertilizer, and the liquid biostimulant) produced by the methods described herein will contain at least one phytohormone or secondary metabolite selected from the group consisting of indole-acetic acid, 12-oxophytodienoic acid, jasmonic acid, salicylic acid, indole 3-acetyl-aspartic acid, jasmonyl isoleucine, abscisic acid, pipecolinic acid, N(δ)-acetylornithine, alpha-tocopherol, gamma-tocopherol, traumatic acid, and 3-indolepropionic acid. In other aspects, the biofertilizer or biostimulant products produced herein will contain at least two phytohormones or secondary metabolites, preferably, they will contain at least three phytohormones or secondary metabolites or at least four phytohormones or secondary metabolites.

The base products (i.e., the general-purpose emulsified biofertilizer, solid biofertilizer, and the liquid biostimulant) can also be further formulated to produce products, sometimes referred to herein as “formulated products,” “formulated compositions,” and the like, for particular uses. In certain embodiments, additives include macronutrients, such as nitrogen and potassium. Products formulated by the addition of macronutrients such as nitrogen and potassium are sometimes referred to as “formulated to grade,” as would be appreciated by the person skilled in the art. In exemplary embodiments comprising a bio-organic nutritional composition prepared from chicken manure, the base composition is formulated to contain about 1.5% to about 3% nitrogen and about 3 to 5% potassium to produce a biofertilizer product suitable for use in the either the organic or the conventional agriculture industry. For conventional agriculture use only, an exemplary embodiment may comprise a base composition formulated to contain about 7% nitrogen, about 22% phosphorus, and about 5% zinc for use as a starter fertilizer to optimize plant growth and development.

In other embodiments, additives include one or more micronutrients as needed or desired. Though the base composition already contains a wide range of micronutrients and other beneficial substances as described in detail below, it is sometimes beneficial to formulate the composition with such additives. Suitable additives for both organic and conventional agriculture include, but are not limited to, blood meal, seed meal (e.g., soy isolate), bone meal, feather meal, humic substances (humic acid, fulvic acid, humin), microbial inoculants, sugars, micronized rock phosphate and magnesium sulfate, to name a few. For conventional agriculture only, suitable additives may also include, but are not limited to, urea, ammonium nitrate, UAN-urea and ammonium nitrate, ammonium polyphosphate, ammonium sulfate, and microbial inoculants. Other materials that are suitable to add to the base product will be apparent to the person of skill in the art.

In some embodiments, the materials added to the base composition are approved for use in conventional farming only. In other embodiments, the materials added to the base composition are themselves approved for use in an organic farming program, such as the USDA NOP, and can thus be used in conventional, organic, or regenerative farming programs.

In particular embodiments, nitrogen is added in the form of sodium nitrate, particularly Chilean sodium nitrate approved for use in organic farming programs. In other embodiments, potassium is added as potassium sulfate. In yet other embodiments, potassium is added as potassium chloride, potassium magnesium sulfate, and/or potassium nitrate. In specific embodiments, the base composition may be formulated to grade either as 1.5-0-3 or 3-0-3 (N-P-K) by adding sodium nitrate and potassium sulfate. Alternatively, the base composition may be formulated to grade as 0-0-5-2S (N-P-K) by adding potassium sulfate for use by both conventional and organic farmers.

The base composition can be formulated any time after it exits the bioreactor (or, in the case of the specialty liquid biostimulant and solid biofertilizer products, after they are separated, e.g., exit the centrifuge) and before it is finished for packaging. In one embodiment, the product is formulated with macronutrients prior to any subsequent processing steps. In this embodiment, the product stream is directed into a formulation product receiving vessel where the macronutrients are added. Other materials can be added at this time, as desired. The formulated product receiver can be equipped with an agitation system to ensure that the formulation maintains the appropriate homogeneity.

In some embodiments, the based products are directed into storage tanks, which may be equipped with pH and temperature controls and/or an agitation system. In particular embodiments, the storage tanks may also be equipped with an oxygen supply system. In such embodiments, the post ATAB general-purpose emulsified biofertilizer and/or the post separation liquid biostimulant, are kept under aerobic conditions by injecting pure oxygen or oxygen enriched air at a rate of from about 0.1 CFM to about 3 CFM per 10,000 gallons of liquid, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 CFM per 10,000 gallons of liquid. Preferably, the pure oxygen or oxygen-enriched air is delivered to the post ATAB liquid product at about 0.25 CFM to about 1.5 CFM per 10,000 gallons of liquid, more preferably at about 0.5 CFM per 10,000 gallons of liquid. In some embodiments, the oxygen is delivered via a plurality of spargers such as those described above. By keeping the post ATAB product under aerobic conditions, the formation of anaerobic compounds is avoided.

Prior to packaging and/or shipping the fluid compositions discussed above (i.e., the general purpose emulsified biofertilizer or the liquid biostimulant) can also be subjected to one or more filtration steps to remove suspended solids. The solids retained by such filtration processes can be returned to the manufacturing process system, e.g., to the aerobic bioreactor.

Filtration can involve various filter sizes. In certain embodiments, the filter size is 100 mesh (149 microns) or smaller. More particularly, the filter size is 120 mesh (125 microns) or smaller, or 140 mesh (105 microns) or smaller, or 170 mesh (88 microns) or smaller, or 200 mesh (74 microns) or smaller, or 230 mesh (63 microns) or smaller, or 270 mesh (53 microns) or smaller, or 325 mesh (44 microns) or smaller, or 400 mesh (37 microns) or smaller. In particular embodiments, the filter size is 170 mesh (88 microns), or 200 mesh (74 microns), or 230 mesh (63 microns), or 270 mesh (53 microns). In certain embodiments, a combination of filtration steps can be used, e.g., 170 mesh, followed by 200 mesh, or 200 mesh followed by 270 mesh filtrations.

Filtration is typically carried out using a vibratory screen, e.g., a stainless mesh screen, drum screen, disc centrifuge, pressure filter vessel, belt press, or a combination thereof. Filtration typically is carried out on products cooled to ambient air temperature, i.e., below about 28° C.-30° C.

Packaging of the finished product can include dispensing the product into containers from which the material can be poured. In certain embodiments, filled containers may be sealed with a membrane cap (“vent cap,” e.g. from W. L. Gore, Elkton, MD) to permit air circulation in the headspace of the containers. These membranes can be hydrophobic and have pores small enough that material cannot leak even in the event the containers are completely inverted. Additionally, the pores can be suitably small (e.g., 0.2 micron) to eliminate the risk of microbial contamination of the container contents.

### Exemplary Embodiment

A non-limiting exemplary embodiment of the manufacturing process for producing liquid and solid compositions from chicken manure is depicted in FIG. 1. As shown in FIG. 1, the manufacturing process 10 typically begins with raw animal manure 15 being loaded into a mixing tank 25. In some embodiments, the manure is conveyed from a truck transporting the manure to the manufacturing plant from a farm. In a preferred embodiment, the raw manure is chicken manure, such as egg layer chicken manure.

In some embodiments, it is necessary to adjust/stabilize the pH of the raw manure. In other embodiments, the pH of the slurry is adjusted rather than the raw manure, it being understood that, in some instances, the pH of the raw manure and/or the slurry is already within the desired pH range thereby alleviating the need to adjust the pH. As depicted in FIG. 1, the raw manure 15 may be stabilized to a pH of about 5.5 to about 8 (preferably, to a pH of about 6 to about 7) by spraying with citric acid 20 either prior to or while being conveyed into the mixing tank 25. The citric acid binds the natural organic ammonia in raw manure. In the mixing tank 25, the stabilized manure may be mixed with water 35 adequate to elevate the moisture level of the manure composition and produce an animal waste slurry with about 84 wt % to about 88 wt % moisture. For instance, in some embodiments, the mixing tank is fitted with 2-micron sintered stainless steel spargers for delivering pure oxygen. During mixing, pure oxygen 30 (>96%) is injected into the slurry at a rate of 0.25 CFM per 10,000 gallons of slurry. The slurry is then heated with steam 40 to about 40-65° C. for a minimum of 15 minutes (preferably at least 1-4 hours) to break down the manure into fine particles and then fully homogenized into a slurry for further processing. Additionally, the step activate native mesophilic bacteria. The temperature of the homogenized slurry is elevated to 65° C. for a minimum of 1 hour to ensure pathogen destruction. A heat exchanger 45 is depicted in FIG. 1 and may be included to provide for consistent temperature control during the mixing step. In particular embodiments, this part of the manufacturing process can be segregated from the rest of the system to reduce the risk that processed fertilizer material could be contaminated by raw manure.

The slurry is then pumped to a degritting system 50 and 60, such as a SLURRYCUP degritting system fitted with a Grit Snail dewatering belt escalator (Hydro International, Hillsboro, Oregon, USA). Briefly, the degritting system 50 used two levels of separation and classification to remove grit as small as 75 microns from the animal waste slurry.

The animal slurry is then pumped to the optional step of particle size reduction. In the particular embodiment depicted in FIG. 1, a particle size reducer 70 is used for particle size reduction to produce a homogenized slurry composition. In some embodiments, the particle size reducer is a macerator, such as the commercially available M MACERATOR pump (SEEPEX GmbH). In others, particle size is reduced by processing the homogenized slurry composition in a colloidal mill, such as a colloidal mill fitted with a stator configured to reduce particle size to less than about 1 micron or less was.

After optional degritting and reducing the particle size, the animal slurry is then fed to the to the aerobic bioreactor 80, where native microorganisms were cultivated under thermophilic and aerobic conditions. In the particular embodiment shown in FIG. 1, there are two aerobic bioreactors in series or parallel (extra bioreactors may be installed to increase the production rate). During the incubation, pure oxygen 90 (>96%) is injected into the animal waste slurry. The microorganisms metabolized the organic components of the animal waste slurry into primary and secondary metabolomic byproducts including, but not limited to, plant growth factors, lipids and fatty acids, phenolics, carboxylic acids/organic acids, nucleosides, amines, sugars, polyols and sugar alcohol, and other compounds. Depending on its age, the animal waste slurry can remain in the aerobic bioreactor 80 under gentle agitation (e.g., full turnover occurs about 10 to about 60 times per hour) for a minimum of about 1 day to a maximum of about 14 days. Once the slurry is subjected to oxygen, mesophilic bacteria begin to replicate and initiate decomposition of organic matter, thereby gradually increasing the slurry temperature is a similar manner to the natural composting process. Once the slurry has achieved autothermal status, after approximately 3 to 12 days a uniform minimum temperature suitable for growth of thermophilic microorganisms is maintained. Moreover, steam heat 85 can be provided, if necessary, to maintain the minimum temperature of the aerobic bioreaction. In preferred embodiments, the animal waste slurry is kept in the aerobic bioreactor at a temperature of at least about 55° C. (preferably between about 60° C. and about 65° C.) for at least about 72 hours.

As shown in FIG. 1, product from the aerobic bioreactor can be processed in one of two ways. In the first process, the digested/decomposed animal waste composition for the production of a general-purpose emulsified biofertilizer 95 can be 92 processed through a colloidal emulsifier and cooled with a heat exchanger 100. During the further processing and storage 105, the pH of the cooled emulsified biofertilizer 95 can be lowered to stabilize the composition for storage. In some embodiments, humic acid can be added to ensure stabilization, and organic nutrients can be added as needed. Prior to shipping or packaging 115, the emulsified biofertilizer product is typically subjected to filtration 110.

In the second process, the digested/decomposed animal waste composition is pumped through a centrifuge 120 to separate the composition into two streams—a substantially liquid component to produce the specialty liquid biostimulant product 130 and a substantially solid component to produce the solid biofertilizer product 125. In a preferred embodiment, centrifuge 120 is a decanting centrifuge (e.g., PANX clarifying centrifuge, Alfa Laval Corporate AB). By performing the digestion step prior to separation, the biomass/biofertilizer now has metabolic compounds as compared to performing the digestion step only on the liquid component after separation. The solid biofertilizer product 125 can be further processed 105 by adjustment of the pH, supplementation of organic nutrients, and/or stabilization via the addition of humic acid. Cooling and drying are not typically necessary and the product can be packaged and shipped without filtration.

The centrifuged liquid (i.e., for production of the liquid biostimulant) can be cooled with a heat exchanger 135 and the pH adjusted to stabilize the composition. Humic acid can also be added to ensure stabilization, and organic nutrients can be added as needed. Prior to shipping or packaging 115, the specialty liquid biostimulant product 130 is typically subjected to microscreen filtration 140.

The following examples are provided to describe the invention in greater detail. They are intended to illustrate, not to limit, the invention.

### Example 1. Chemical Composition of the Emulsified Biofertilizer, Liquid Biostimulant, and the Solid Biofertilizer Produced by the Invention

The chemical composition of the animal waste slurry was measured before ATAB and subsequent to the separation. Briefly, 20 tons of raw egg layer chicken manure containing 50 wt % moisture was fed into a mixing tank. The raw manure was stabilized to a pH of about 7 by spraying with citric acid. Then, water was added to the raw manure to elevate the moisture level of the manure composition and produce an animal waste slurry at about 88 wt % moisture. The mixing tank was fitted with 2-micron sintered stainless steel spargers for delivering pure oxygen. During mixing, pure oxygen (>96%) was injected into the slurry at a rate of 0.25 CFM per 10,000 gallons of slurry. The slurry was then heated with steam to 45° C. for a minimum of 1 hour to break down the manure into fine particles and was fully homogenized into a slurry for further processing. The mixing tank process parameters for the preparation of feedstock material are shown in Table 4.

TABLE 4
Mixing Tank Process Parameters.

| | Range of Operational | | |
|---|---|---|---|
| Process Parameter | Parameters | | Notes |
| Mixing Tank | 3,000 to 4,000 gallons | | Tank Size 5,000 gallons |
| Axial Turbine Mixer | 45 to 60 HZ | 75 to 100% | Spins clockwise, forces |
| | | | material down turns tank |
| | | | over 1 to 3 times per minute |
| Macerator | 45 to 60 HZ | 75 to 100% | Reduces particle size, |
| | | | homogenizes mix |
| Pump | 45 to 60 HZ | 75 to 100% | Pump Size 3 HP, Positive |
| | | | Displacement |
| Mixing Tank pH | 6.5 to 7.0 | | Citric acid addition varies |
| | | | from patch to patch typically |
| | | | 1 to 2% by weight addition |
| Mixing Tank | 40° C. to 65° C. | | Measured by thermowell via |
| Temperature | 60 minutes | | tank penetration |
| Moisture % | 84 to 90% | | Measured by loss of drying |
| Viscosity | 2000 to 3000 CPS | | |
| Heating Method | Direct Steam Injection 3 | | Direct steam injection to |
| | to 8 PSI | | heat the material |
| Oxygenation Method | Direct Pure Oxygen | | Oxygen delivery via 2- |
| | Injection at 0.25 CFM per | | micron sintered stainless |
| | 10,000 gallons | | steel spargers |

HZ, hertz;
HP, horsepower;
CPS, centipoise;
PSI, pounds per square inch;
CFM, cubic feet per minute

Next, the animal slurry was then fed to the to the aerobic bioreactor, where endogenous microorganisms were cultivated under thermophilic and aerobic conditions. During the incubation, pure oxygen (>96%) was injected into the animal waste slurry at a rate of 1.0 CFM per 1,000 gallons. The animal waste slurry remained in the aerobic bioreactor under gentle agitation (e.g., full turnover occurs about 10 to about 60 times per hour) for about 1 to about 14 days at a uniform minimum temperature of about 55° C. The aerobic bioreactor process parameters are provided in Table 5.

TABLE 5
Bioreactor process parameters

| | Range of | | | |
|---|---|---|---|---|
| | Operational | | | |
| Process Parameter | Parameters | | | Notes |
| Data collection Record | 1 minute to | | | How frequent the PLC records |
| | 30 minutes | | | data |
| Hydraulic Retention time/ | 1 to 14 days | | | How long the material resides |
| Residence time of material in | | | | in the bioreactor |
| reactors | | | | |
| Bioreactor Mixing Pump (Hz) | 0 to 60 HZ | 0-100% | 0-750 GPM | 0-750 GPM pump |
| | | | | 15 HP pump |
| Oxygen Delivery | 1.0 CFM per | | | Injection by 2-micron sintered |
| | 1,000 | | | stainless steel spargers |
| | gallons | | | |
| Bioreactor ORP (mV) | −200 to +50 | | | Analytical tool |
| | mV | | | |
| Bioreactor pH | 6.5 to 7.0 | | | Analytical tool |
| Bioreactor Temperature (° C.) | 30 to 75° C. | | | Analytical tool |
| pH peristaltic pump | 0-8 GPH | | | pH adjustment tool ON/OFF |
| | | | | signal processed via 4-20ma |
| | | | | signal from Bioreactor pH |
| | | | | probe |
| Influent to Bioreactor Pump PSI | 3 to 5 PSI | | | Pressure into the Pump |

CFM, cubic feet per minute,
GPH, gallons per hour;
PSI, pounds per square inch;
Hz, hertz;
ORP, oxidation reduction potential:
PLC, programmable logic controller

The digested/decomposed animal waste slurry was then pumped through a decanter centrifuge (e.g., PANX clarifying centrifuge, Alfa Laval Corporate AB) at a rate of about 100 gpm to separate the composition into a substantially liquid biostimulant and a substantially solid biofertilizer. Suitable centrifuge parameters for the separation of the solid and liquid fractions are shown in Table 6.

TABLE 6
Centrifuge parameters

| | Range of | |
|---|---|---|
| | Operational | |
| Process Parameter | Parameters | Notes |
| Decanting | 3250 RPM Max | |
| Centrifuge | | |
| Influent volume | 25-30 gallons per minute | Slurry from ATAB being |
| | | pumped into centrifuge |
| Effluent volume | 25% of input manure by | Liquid fraction exiting |
| | weight is extracted as | the centrifuge |
| | finely suspended solids | |
| Solids separation | 75% of input manure by | Solids fraction discharge |
| | weight | |
| Differential | 7 to 12% | |
| Bowl Speed | 2900 to 3250 RPM | |
| Torque Scroll | 10% or less | |

RPM, revolutions per minute

The chemical composition of the raw feedstock (prior to mixing), emulsified biofertilizer (after digestion, but prior to separation, liquid biostimulant (after separation), and solid biofertilizer (after separation) were determined from the average of two exemplary runs of the process described herein. The results are shown in Table 7A and compared to products generated from a previous method where the manure slurry is separated prior to ATAB shown in Table 7B. In Table 7B, the composition of the raw manure, the separated liquid stream prior to ATAB (centrate pre-bioreactor), the digested liquid biostimulant following ATAB (bioreactor centrate), and the separated, undigested solid component (cake) that is not subject to ATAB are summarized. In the previous method, only the liquid component following separation (bioreactor centrate) is subjected to ATAB. The solid component (cake) is not subjected to microbial digestion and therefore does not meet the requirements of the National Organic Program or the FDA Produce Food Safety requirements. As shown in Tables 7A and 7B, the instant method produces three biofertilizer/biostimulant products with increased plant nutrients, including twice the total nitrogen content, as the liquid biostimulant of the previous method. What is more, all three products produced by the instant method are subject to ATAB and suitable for use under the National Organic Program or the FDA Produce Food Safety requirements

TABLE 7A
Chemical composition of raw manure and products
produced by the instant method.

| | Raw | Emulsified | Liquid | Solid |
|---|---|---|---|---|
| | Manure | Biofertilizer | Biostimulant | Biofertilizer |
| Composition | Value AVG | Value AVG | Value AVG | Value AVG |
| Ammonium | 0.88% | 0.59% | 0.58% | 0.45% |
| Nitrogen | | | | |
| Organic | 1.89% | 0.26% | 0.28% | 0.42% |
| Nitrogen | | | | |
| TKN | 2.78% | 0.88% | 0.86% | 0.86% |
| P2O5 | 2.03% | 0.82% | 0.23% | 2.59% |
| K2O | 1.40% | 0.50% | 0.55% | 0.42% |
| Sulfur | 0.39% | 0.09% | 0.10% | 0.14% |
| Calcium | 3.56% | 3.27% | 0.22% | 7.56% |
| Magnesium | 0.36% | 0.23% | 0.05% | 0.47% |
| Sodium | 0.33% | 0.09% | 0.07% | 0.07% |
| Copper ppm | 90 | <20 | <20 | <20 |
| Iron ppm | 490 | 462 | 86 | 901 |
| Manganese | 219 | 77 | 29 | 245 |
| ppm | | | | |
| Zinc ppm | 288 | 85 | 33 | 243 |
| Moisture | 52% | 89.20% | 96.10% | 63.90% |
| Total Solids | 48% | 10.80% | 3.90% | 36.10% |
| pH | 7.6 | 7.4 | 7.8 | 7.1 |
| Total Carbon | 17.07% | 4.25% | 2.30% | 9.22% |

TABLE 7B
Chemical composition of raw manure and products produced by previous method.

| | | Centrate Pre- | Bioreactor | cake (not subject to |
|---|---|---|---|---|
| | Raw Manure | bioreactor | Centrate | ATAB) |
| Composition | Value AVG | Value AVG | Value AVG | Value AVG |
| Ammonium Nitrogen | 0.88% | 0.53% | 0.21% | 0.96% |
| Organic Nitrogen | 1.89% | 0.35% | 0.10% | 1.21% |
| TKN | 2.78% | 0.88% | 0.31% | 2.05% |
| P2O5 | 2.03% | 0.77% | 0.24% | 1.82% |
| K2O | 1.40% | 0.48% | 0.41% | 0.59% |
| Sulfur | 0.39% | 0.08% | 0.06% | 0.13% |
| Calcium | 3.56% | 1.20% | 0.15% | 4.47% |
| Magnesium | 0.36% | 0.11% | 0.04% | 0.26% |
| Sodium | 0.33% | 0.06% | 0.05% | 0.07% |
| Copper ppm | 90 | >25 | >25 | 18 |
| Iron ppm | 490 | 259 | 52 | 495 |
| Manganese ppm | 219 | 81 | 20 | 206 |
| Zinc ppm | 288 | 89 | 22 | 213 |
| Moisture | 52% | 88% | 97% | 60.93% |
| Total Solids | 48% | 12% | 3% | 39.07% |
| pH | 7.6 | 7.3 | 6.6 | 8.1 |
| Total Carbon | 17.07% | 3.00% | | 14.89% |

The present invention is not limited to the embodiments described and exemplified herein. It is capable of variation and modification within the scope of the appended claims.

1. A process for manufacturing a bionutritional composition from animal waste, the process comprising:
(a) adjusting the pH of the animal waste to about 5 to about 8 to produce a stabilized animal waste composition;
(b) adjusting moisture content of the stabilized animal waste composition to at least about 75 wt % to produce an aqueous animal waste slurry;
(c) subjecting the aqueous animal waste slurry to an autothermal thermophilic aerobic bioreaction to produce a digested animal waste composition that comprises: (i) delivery of pure oxygen or oxygen enriched air to the aqueous animal waste slurry to maintain the aqueous animal waste slurry under aerobic conditions suitable for the growth of thermophilic bacteria for a first period of time; and (ii) maintaining the aqueous animal waste slurry at a temperature suitable for the growth of thermophilic bacteria for a second period of time; and
(d) subjecting the digested animal waste composition to at least one additional processing step comprising (1) emulsifying the digested animal waste composition to produce an emulsified component; or (2) optionally separating a substantially solid component and a substantially liquid component of the digested animal waste composition; and
wherein the stabilized animal waste composition, the aqueous animal waste slurry and the digested animal waste composition are maintained at a pH of at about 5 to about 8 throughout the process.

2. The process of claim 1, further comprising, prior to step (c);
(a) allowing the components of the aqueous animal waste slurry to remain in contact for a period of time; or
(b) removing at least a portion of inorganic solids from the aqueous animal waste slurry; or
(c) reducing particle size of organic solids in the aqueous animal waste slurry; or
(d) any combination of (a), (b), and (c).

3-5. (canceled)

6. The process of claim 2, wherein:
(a) the portion of the inorganic solids is removed from the aqueous animal waste slurry by filtration or by a hydraulic grit remover; or
(b) the reducing particle size step comprises a colloidal mill, a homogenizer, a macerator, or a dispersing grinder; or
(c) both (a) and (b).

7. (canceled)

8. (canceled)

9. The process of claim 1, wherein step (d) further comprises one or more additional processing steps comprising (1) adjusting the temperature to less than about 40° C., (2) adding a stabilizer, or (3) both adjusting the temperature to less than about 40° C. and adding a stabilizer.

10. The process of claim 9, wherein the stabilizer is humic acid.

11. The process of claim 1, wherein the animal waste is chicken waste.

12. (canceled)

13. The process of claim 1, wherein the first period of time and the second period of time occur substantially simultaneously.

14. The process of claim 1, further comprising delivery of pure oxygen or oxygen enriched air to the aqueous animal waste slurry prior to step (c) for a third period of time to reduce the concentration of anaerobic compounds in the aqueous slurry, wherein the aqueous animal waste slurry comprises a residual dissolved oxygen concentration of at least about 1 parts per million due to the delivery of pure oxygen or oxygen enriched air.

15. (canceled)

16. (canceled)

17. The process of claim 14, wherein the anaerobic compounds comprise hydrogen sulfide.

18.

[symbol]

19. The process of claim 1, wherein the pure oxygen or oxygen enriched air is injected into the aqueous animal waste slurry in step (c) at a rate of about 0.5 CFM to about 1.5 CFM per 10,000 gallons.

20. (canceled)

21. The process of claim 1, wherein step (b) comprises adjusting the moisture content of the stabilized animal waste composition to between about 80 wt % and about 92 wt % to produce the aqueous animal waste slurry;

22. The process of claim 1, wherein the pH of the animal waste is adjusted by adding an acid.

23. The process of claim 22, wherein the acid is citric acid.

24. (canceled)

25. (canceled)

26. The process of any one of claims 1-25, wherein the aerobic conditions in the autothermal thermophilic aerobic bioreaction comprise a dissolved oxygen level of between about 2 mg/l and about 6 mg/l.

27. The process of any one of claims 1-26, wherein stabilized animal waste composition, the aqueous animal waste slurry and the digested animal waste composition are maintained at a pH between about 5.5 and about 7.5 throughout the process.

28. The process of any one of claims 14-27, wherein the third period of time is at least about 15 minutes.

29. The process of claim 14, wherein the third period of time is at least about 1 hour.

30. The process of claim 1, wherein both the first period of time and the second period of time are at least about 1 day.

31. The process of claim 30, wherein both the first period of time and the second period of time are at least about 3 days.

32. An emulsified biofertilizer, liquid biostimulant, and/or solid biofertilizer composition for application to plants and soils, wherein the emulsified biofertilizer, liquid biostimulant, and/or solid biofertilizer composition is produced by the process of claim 1.

33. The composition of claim 32, comprising:
(a) one or more phytohormones or secondary metabolites selected from the group consisting of indole-acetic acid, 12-oxophytodienoic acid, jasmonic acid, salicylic acid, indole 3-acetyl-aspartic acid, jasmonyl isoleucine, abscisic acid, pipecolinic acid, N(δ)-acetylornithine, alpha-tocopherol, gamma-tocopherol, traumatic acid, and 3-indolepropionic acid; or
(b) a macronutrient or micronutrient;
(c) both (a) and (b).

34. (canceled)

35. (canceled)

36. The composition of claim 32,
(a) formulated for application to soil or a medium in which a plant is growing or will be grown; or
(b) formulated for application to a seed or plant part; or
(c) suitable for use in an organic program; or
(d) any combination of (a), (b), and (c); or
(e) wherein the composition is admixed with a synthetic or chemical fertilizer or pesticides or other crop inputs for use in conventional agriculture.

37-39. (canceled)

40. A process for manufacturing a bionutritional composition from animal waste, the process comprising:
(a) adjusting the pH of the animal waste to about 5 to about 8 to produce a stabilized animal waste composition;
(b) adjusting moisture content of the stabilized animal waste composition to at least about 75 wt % to produce an aqueous animal waste slurry;
(c) allowing the components of the aqueous animal waste slurry to remain in contact for a period of time;
(d) reducing particle size of organic solids in the aqueous animal waste slurry;
(e) subjecting the aqueous animal waste slurry to an autothermal thermophilic aerobic bioreaction (ATAB) for at least about 1 day to produce a digested animal waste composition wherein:
(i) the ATAB of the aqueous animal waste slurry occurs in one or more bioreactors comprising a pure oxygen or oxygen enriched air delivery system;
(ii) the delivery system injects the pure oxygen or oxygen enriched air into the aqueous animal waste slurry at a rate of about 0.25 CFM to about 1.5 CFM per 10,000 gallons to maintain the aqueous animal waste slurry under aerobic conditions suitable for the growth of mesophilic and thermophilic bacteria; and
(iii) the temperature of the aqueous animal waste slurry in the bioreactor is maintained at a temperature between about 55° C. to about 75° C.; and
(f) subjecting the digested animal waste composition to one or more additional processing steps comprising (1) adding a stabilizer to the digested animal waste composition; (2) adjusting temperature of the digested animal waste composition to less than about 40° C.; (3) adding one or more organic nutrients to the digested animal waste composition; and/or (4) optionally separating a substantially solid component and a substantially liquid component of the digested animal waste composition; and
wherein the stabilized animal waste composition, the aqueous animal waste slurry and the digested animal waste composition are maintained at a pH of at about 5 to about 8 throughout the process.

41-48. (canceled)
